(19) United States
(12) Patent Application Publication
(10) Pub. No.: US 2019/0114576 A1
(43) Pub. Date: Apr. 18, 2019

(54) PLATFORMS, SYSTEMS, MEDIA, AND METHODS FOR HIGH-UTILIZATION PRODUCT EXPERT LOGISTICS

(71) Applicant: Enjoy Technology, Inc., Menlo Park, CA (US)

(72) Inventors: Ronald B. Johnson, Atherton, CA (US); Omar Al-Jadda, Sunnyvale, CA (US); Tara Loy Bass, San Mateo, CA (US); Ryan Mackenzie Glassett, San Francisco, CA (US); Evan Travis Anderson, San Francisco, CA (US); Philippe Miguel Huibonhoa, Santa Clara, CA (US); Ana Cheng Z Liu, Incline Village, NV (US); Lucas Emmanuel Ramadan, San Francisco, CA (US); Judith Diana Pachciarz Wacker, Mountain View, CA (US); Nam Quoc Tran, Union City, CA (US); Thomas Kent Suiter, Woodside, CA (US); Sean Patrick Foy, San Martin, CA (US); Yang-Sup Chung, Gilroy, CA (US); Sandhya Jagannath, Palo Alto, CA (US); Anil Gandham, Los Altos Hills, CA (US); Michael Gregory Pearce, San Francisco, CA (US); Laila Atassi, San Carlos, CA (US); Michael Shane Rogers, Belmont, CA (US); Nina Revko, Newark, CA (US)

(21) Appl. No.: 16/162,265

(22) Filed: Oct. 16, 2018

Related U.S. Application Data
(60) Provisional application No. 62/573,540, filed on Oct. 17, 2017.

(51) Int. Cl. G06Q 10/06; G06Q 10/08; G06Q 30/06

(52) U.S. Cl. CPC G06Q 10/063116; G06Q 30/0601; G06Q 10/087; G06Q 10/0836

(57) ABSTRACT

Described are platforms, systems, media, and methods for maintaining a database of items associated with one or more skill requirements and a visit duration; maintaining a database of experts associated with one or more skill proficiencies, a location, and a schedule; receiving a request from a consumer for delivery by an expert of one or more items in the database to a consumer address; identifying experts in the database having skill proficiencies matching the skill requirements of the one or more items and available in a timeslot for the visit duration of the one or more items; presenting timeslots for which one or more experts are identified to the consumer and allowing the consumer to select a timeslot; and selecting an expert from among the identified experts in the selected timeslot based on shortest travel time; provided that utilization of the selected expert exceeds a predetermined utilization threshold.

### CROSS-REFERENCE TO RELATED APPLICATIONS

This application claims the benefit of U.S. Provisional Application No. 62/573,540, filed Oct. 17, 2017, which application is incorporated herein by reference.

### BACKGROUND OF THE INVENTION

Mobile inventory is an alternative to more traditional point to point deliveries, where one or more items selected to meet sales orders are carried from a fixed location to a consumer via a mobile inventory unit vehicle. In this model an inventory is deployed onto one or more vehicles and orders are allocated to each vehicle based on their current or predicted location, allowing for rapid fulfillment and delivery of products to customers in defined geographical locations.

### SUMMARY OF THE INVENTION

Currently available systems for delivering consumer items generally comprises a user ordering an item, and requesting instillation or support on that item in parallel or tandem with the delivery. As orders are placed, one or more items are loaded onto a truck and sent out to deliver those specific items ordered by the users. These systems, however, are less capable of quickly delivering items, because an item can only be delivered after the order has been accepted and the delivery vehicle has been loaded with that item and specific instructions to the driver to deliver that item in a set route. Further, because the route is fixed at the beginning of each delivery run, currently available delivery systems, are often inefficient if drivers and the trucks are not implemented between delivery times, or after all the scheduled items have been delivered. As such, there is a current unmet need for a flexible logistics platform comprising mobile inventory units capable of delivering orders submitted after it leaves the warehouse, and during unscheduled periods of time. In addition, a need for an improved logistics platform that more effectively utilizes computer resources exists.

Such a platform with real-time scheduling would allow for a more efficient use of delivery personnel, delivery vehicles, and resources, and allow for faster deliveries, the ability to simultaneously deliver add-on items, and would ensure that experts with the proper skills help to deliver and install each item.

Advantageously, the platforms, systems, media, and methods described herein, in some embodiments, include technical improvements that enhance the speed and responsiveness of the hardware resources, e.g., memory, processors, storage, and the like, required to achieve the described logistic. By way of example, in some cases, large numbers of potential combinations of scheduling options are calculated in parallel and configured to make use of parallel computing. In some of these cases, the potential combinations of scheduling options are calculated in parallel across multiple servers, server clusters, and/or clouds. By way of further example, in some cases, large numbers of potential combinations of scheduling options are calculated by pre-loading all data required for the calculations into memory prior to starting the calculations. In some of these cases, queries to databases are not needed once the calculations are begun and I/O operations are halted with regard to the databases (and optionally resumed upon completion of the calculations) to improve performance.

One aspect provided herein is a multimodal logistics platform configured to schedule a plurality of real-time orders and future orders within a set processing period, the platform comprising: a consumer processor configured to provide a consumer application comprising a software module presenting an interface allowing a consumer to browse a plurality of items and submit one or more of the plurality of real-time orders and future orders, each real-time order and future order comprising one or more of the plurality of items for delivery by one or more experts, a consumer address, and a delivery timeslot; and a server processor configured to provide a server application comprising: a database of items, each item associated with a skill requirement, a visit duration, a burden score, a time-of-day requirement, and a SKU; a database of experts, each expert associated with a skill proficiency, and a current expert schedule; and a database of one or more mobile inventory units (MIUs), each MIU associated with a stock of items, a current MIU position, and a current MIU schedule; and a scheduling parallel processor configured to provide: a server real-time mode application comprising: a communication module receiving at least the items, the experts, and the MIUs from the server processor, and receiving the real-time orders from the consumer processor; a combinator module applying a first operational rule in parallel to the real-time orders, the experts, and the one or more MIUs, based on the real-time order, to determine, a plurality of real-time delivery schemes that adhere to the first operational rule; a filter module applying a second operational rule to the plurality of real-time delivery schemes, to select two or more filtered real-time delivery schemes that adhere to the second operational rule; and a scorer module applying a third operational rule to the filtered real-time delivery schemes, to score the filtered real-time delivery schemes and determine which filtered real-time delivery scheme has the best score; and a server future mode application comprising: a communication module receiving at least the items, the experts, and the MIUs from the server processor, and receiving a future order from the consumer processor; a zoning module assigning a zone to each future order based on the consumer address; and an availabilities module determining in parallel a plurality of future delivery schemes for each of a plurality of future days based on the zone, the experts, the MIUs, or any combination thereof, wherein the future delivery scheme comprises a plurality of the future orders within a delivery window on one of the future days; provided that the logistics platform is configured to meet or exceed a predetermined utilization threshold.

In some embodiments, the predetermined utilization threshold is measured in dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, each expert in the database of experts is further associated with an expert inventory. In some embodiments, the server application further comprises a database of warehouses, each warehouse associated with a warehouse inventory and a warehouse location, and wherein the combinator module further applies the first operational rule to the warehouses. In some embodiments, the server application is configured to allow an administrator to modify at least one of the first operational rule, the second operational rule, and the third operational rule in real-time, and without reprograming the server application. In some embodiments, at least one of the server processor, the scheduling processor, and the consumer processor comprises a parallel processor. In some embodiments, the parallel processor comprises a distributed computing parallel processor. In some embodiments, the server application further comprises a dispatch module communicating the filtered delivery scheme with the best score to an administrator. In some embodiments, the server application further comprises a notification module communicating a delivery update to the consumer. In some embodiments, the server application further comprises a scheduling module modifying the current expert schedule of at least one of the experts in real-time to include the filtered delivery scheme with the best score. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a visit location factor; an expert training factor; a visit location zone factor; a demand forecasting factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of real-time orders. In some embodiments, the server application is capable of updating at least one of the database of items, the database of experts and the database of one or more MIUs in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services.

In some embodiments, the delivery timeslot is about 10 minutes to about 360 minutes. In some embodiments, the delivery timeslot is about 10 minutes to about 20 minutes, about 10 minutes to about 30 minutes, about 10 minutes to about 40 minutes, about 10 minutes to about 50 minutes, about 10 minutes to about 60 minutes, about 10 minutes to about 120 minutes, about 10 minutes to about 180 minutes, about 10 minutes to about 240 minutes, about 10 minutes to about 300 minutes, about 10 minutes to about 360 minutes, about 20 minutes to about 30 minutes, about 20 minutes to about 40 minutes, about 20 minutes to about 50 minutes, about 20 minutes to about 60 minutes, about 20 minutes to about 120 minutes, about 20 minutes to about 180 minutes, about 20 minutes to about 240 minutes, about 20 minutes to about 300 minutes, about 20 minutes to about 360 minutes, about 30 minutes to about 40 minutes, about 30 minutes to about 50 minutes, about 30 minutes to about 60 minutes, about 30 minutes to about 120 minutes, about 30 minutes to about 180 minutes, about 30 minutes to about 240 minutes, about 30 minutes to about 300 minutes, about 30 minutes to about 360 minutes, about 40 minutes to about 50 minutes, about 40 minutes to about 60 minutes, about 40 minutes to about 120 minutes, about 40 minutes to about 180 minutes, about 40 minutes to about 240 minutes, about 40 minutes to about 300 minutes, about 40 minutes to about 360 minutes, about 50 minutes to about 60 minutes, about 50 minutes to about 120 minutes, about 50 minutes to about 180 minutes, about 50 minutes to about 240 minutes, about 50 minutes to about 300 minutes, about 50 minutes to about 360 minutes, about 60 minutes to about 120 minutes, about 60 minutes to about 180 minutes, about 60 minutes to about 240 minutes, about 60 minutes to about 300 minutes, about 60 minutes to about 360 minutes, about 120 minutes to about 180 minutes, about 120 minutes to about 240 minutes, about 120 minutes to about 300 minutes, about 120 minutes to about 360 minutes, about 180 minutes to about 240 minutes, about 180 minutes to about 300 minutes, about 180 minutes to about 360 minutes, about 240 minutes to about 300 minutes, about 240 minutes to about 360 minutes, or about 300 minutes to about 360 minutes. In some embodiments, the delivery timeslot is about 10 minutes, about 20 minutes, about 30 minutes, about 40 minutes, about 50 minutes, about 60 minutes, about 120 minutes, about 180 minutes, about 240 minutes, about 300 minutes, or about 360 minutes. In some embodiments, the delivery timeslot is at least about 10 minutes, about 20 minutes, about 30 minutes, about 40 minutes, about 50 minutes, about 60 minutes, about 120 minutes, about 180 minutes, about 240 minutes, about 300 minutes, or about 360 minutes. In some embodiments, the delivery timeslot is at most about 10 minutes, about 20 minutes, about 30 minutes, about 40 minutes, about 50 minutes, about 60 minutes, about 120 minutes, about 180 minutes, about 240 minutes, about 300 minutes, or about 360 minutes.

In some embodiments, a set real-time prioritization percentage of the current expert schedule is dedicated to real-time orders. In some embodiments, the set real-time prioritization percentage is about 15% to about 50%. In some embodiments, the set real-time prioritization percentage is about 15% to about 20%, about 15% to about 25%, about 15% to about 30%, about 15% to about 35%, about 15% to about 40%, about 15% to about 45%, about 15% to about 50%, about 20% to about 25%, about 20% to about 30%, about 20% to about 35%, about 20% to about 40%, about 20% to about 45%, about 20% to about 50%, about 25% to about 30%, about 25% to about 35%, about 25% to about 40%, about 25% to about 45%, about 25% to about 50%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50%. In some embodiments, the set real-time prioritization percentage is about 15%, about 20%, about 25%, about 30%, about 35%, about 40%, about 45%, or about 50%. In some embodiments, the set real-time prioritization percentage is at least about 15%, about 20%, about 25%, about 30%, about 35%, about 40%, about 45%, or about 50%. In some embodiments, the set real-time prioritization percentage is at most about 15%, about 20%, about 25%, about 30%, about 35%, about 40%, about 45%, or about 50%.

In some embodiments, set processing period is about 0.001 milliseconds (ms) to about 10 ms. In some embodiments, set processing period is about 0.001 ms to about 0.005 ms, about 0.001 ms to about 0.01 ms, about 0.001 ms to about 0.05 ms, about 0.001 ms to about 0.1 ms, about 0.001 ms to about 0.5 ms, about 0.001 ms to about 1 ms, about 0.001 ms to about 2 ms, about 0.001 ms to about 4 ms, about 0.001 ms to about 6 ms, about 0.001 ms to about 8 ms, about 0.001 ms to about 10 ms, about 0.005 ms to about 0.01 ms, about 0.005 ms to about 0.05 ms, about 0.005 ms to about 0.1 ms, about 0.005 ms to about 0.5 ms, about 0.005 ms to about 1 ms, about 0.005 ms to about 2 ms, about 0.005 ms to about 4 ms, about 0.005 ms to about 6 ms, about 0.005 ms to about 8 ms, about 0.005 ms to about 10 ms, about 0.01 ms to about 0.05 ms, about 0.01 ms to about 0.1 ms, about 0.01 ms to about 0.5 ms, about 0.01 ms to about 1 ms, about 0.01 ms to about 2 ms, about 0.01 ms to about 4 ms, about 0.01 ms to about 6 ms, about 0.01 ms to about 8 ms, about 0.01 ms to about 10 ms, about 0.05 ms to about 0.1 ms, about 0.05 ms to about 0.5 ms, about 0.05 ms to about 1 ms, about 0.05 ms to about 2 ms, about 0.05 ms to about 4 ms, about 0.05 ms to about 6 ms, about 0.05 ms to about 8 ms, about 0.05 ms to about 10 ms, about 0.1 ms to about 0.5 ms, about 0.1 ms to about 1 ms, about 0.1 ms to about 2 ms, about 0.1 ms to about 4 ms, about 0.1 ms to about 6 ms, about 0.1 ms to about 8 ms, about 0.1 ms to about 10 ms, about 0.5 ms to about 1 ms, about 0.5 ms to about 2 ms, about 0.5 ms to about 4 ms, about 0.5 ms to about 6 ms, about 0.5 ms to about 8 ms, about 0.5 ms to about 10 ms, about 1 ms to about 2 ms, about 1 ms to about 4 ms, about 1 ms to about 6 ms, about 1 ms to about 8 ms, about 1 ms to about 10 ms, about 2 ms to about 4 ms, about 2 ms to about 6 ms, about 2 ms to about 8 ms, about 2 ms to about 10 ms, about 4 ms to about 6 ms, about 4 ms to about 8 ms, about 4 ms to about 10 ms, about 6 ms to about 8 ms, about 6 ms to about 10 ms, or about 8 ms to about 10 ms. In some embodiments, set processing period is about 0.001 ms, about 0.005 ms, about 0.01 ms, about 0.05 ms, about 0.1 ms, about 0.5 ms, about 1 ms, about 2 ms, about 4 ms, about 6 ms, about 8 ms, or about 10 ms. In some embodiments, set processing period is at least about 0.001 ms, about 0.005 ms, about 0.01 ms, about 0.05 ms, about 0.1 ms, about 0.5 ms, about 1 ms, about 2 ms, about 4 ms, about 6 ms, about 8 ms, or about 10 ms. In some embodiments, set processing period is at most about 0.001 ms, about 0.005 ms, about 0.01 ms, about 0.05 ms, about 0.1 ms, about 0.5 ms, about 1 ms, about 2 ms, about 4 ms, about 6 ms, about 8 ms, or about 10 ms.

In some embodiments, the communication module of the server real-time mode application receives at least the items, the experts, and the MIUs from the server processor before the combinator module applies the first operational rule. In some embodiments, scheduling parallel processor is further configured to provide a backorder application comprising: a communication module receiving at least the items, the experts, and the MIUs from the server processor, and receiving an out-of-stock order from the consumer processor, wherein the item comprises an out-of-stock item or an unreleased item; a zoning module assigning a zone to each out-of-stock order based on the consumer address; and an availabilities module determining in parallel a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

Another aspect provided herein is a multimodal logistics computer-implemented system comprising: a digital processing device comprising: at least one processor, an operating system configured to perform executable instructions, a memory, and a computer program including instructions executable by the digital processing device to create a high-utilization product expert logistics application comprising: a consumer module receiving a real-time order and a future order submitted by a consumer, the real-time order and the future order comprising one or more items selected from a plurality of items for delivery by one or more experts, a consumer address, and a delivery timeslot; a database of items, each item associated with a skill requirement, a visit duration, a burden score, a time-of-day requirement, and a SKU; a database of experts, each expert associated with a skill proficiency and a current expert schedule; a database of one or more mobile inventory units (MIUs), each MIU associated with a stock of items, a current MIU position, and a current MIU schedule; a real-time parallel scheduling module: applying a first operational rule to the real-time order, the experts, and the one or more MIUs, to determine a plurality of possible delivery schemes that adhere to the first operational rule; applying a second operational rule to the plurality of possible delivery schemes, to select two or more filtered delivery schemes that adhere to the second operational rule; and applying a third operational rule to the filtered delivery schemes, to score the filtered delivery schemes and determine which filtered delivery scheme has the best score; and a future parallel scheduling module: assigning a zone to each future order based on the consumer address; and determining in parallel a plurality of future delivery schemes for each of a plurality of future days based on the zone, the experts, the MIUs, or any combination thereof, wherein the future delivery scheme comprises a plurality of the orders within a delivery window on one of the future days; provided that the application configured to, on average, meet or exceed a predetermined utilization threshold.

In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, each expert in the database of experts is further associated with an expert inventory. In some embodiments, the logistics application further comprises a database of warehouses, each warehouse associated with a warehouse inventory and a warehouse location, and wherein the combinator module further applies the first operational rule to the warehouses. In some embodiments, the logistics application is configured to allow an administrator to modify at least one of the first operational rule, the second operational rule, and the third operational rule in real-time, and without reprograming the logistics application. In some embodiments, the logistics application further comprises a dispatch module communicating the filtered delivery scheme with the best score to an administrator. In some embodiments, the logistics application further comprises a notification module communicating a delivery update to the consumer. In some embodiments, the logistics application further comprises a scheduling module modifying the current expert schedule of at least one of the experts to include the filtered delivery scheme with the best score. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a visit location factor; an expert training factor; a visit location zone factor; a demand forecasting factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUS in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services. In some embodiments, the delivery timeslot is about 10 minutes to about 6 hours. In some embodiments, a set real-time prioritization percentage of the current expert schedule is dedicated to real-time orders. In some embodiments, the set real-time prioritization percentage is about 15% to about 50%. In some embodiments, the communication module of the server real-time mode application receives at least the items, the experts, and the MIUs from the server processor before the combinator module applies the first operational rule. In some embodiments, scheduling parallel processor is further configured to provide a backorder application comprising: a communication module receiving at least the items, the experts, and the MIUs from the server processor, and receiving the future orders from the consumer processor, wherein the item comprises an out-of-stock item or an unreleased item; a zoning module, assigning a zone to each future order based on the consumer address; and an availabilities module determining in parallel a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

Another aspect provided herein is a non-transitory computer-readable storage media encoded with a computer program including instructions executable by a processor to create a high-utilization product expert logistics application comprising: a consumer module receiving a real-time order and a future order submitted by a consumer, the real-time order and the future order comprising one or more items selected from a plurality of items for delivery by one or more experts, a consumer address, and a delivery timeslot; a database of items, each item associated with a skill requirement, a visit duration, a burden score, a time-of-day requirement, and a SKU; a database of experts, each expert associated with a skill proficiency and a current expert schedule; a database of one or more mobile inventory units (MIUs), each MIU associated with a stock of items, a current MIU position, and a current MIU schedule; a real-time parallel scheduling module: applying a first operational rule to the real-time order, the experts, and the one or more MIUs, to determine a plurality of possible delivery schemes that adhere to the first operational rule; applying a second operational rule to the plurality of possible delivery schemes, to select two or more filtered delivery schemes that adhere to the second operational rule; and applying a third operational rule to the filtered delivery schemes, to score the filtered delivery schemes and determine which filtered delivery scheme has the best score; and a future parallel scheduling module: assigning a zone to each future order based on the consumer address; and determining in parallel a plurality of future delivery schemes for each of a plurality of future days based on the zone, the experts, the MIUs, or any combination thereof, wherein the future delivery scheme comprises a plurality of the orders within a delivery window on one of the future days; provided that the application is configured to meet or exceed a predetermined utilization threshold.

In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, the processor comprises a parallel processor. In some embodiments, the parallel processor comprises a distributed computing parallel processor. In some embodiments, each expert in the database of experts is further associated with an expert inventory. In some embodiments, the logistics application further comprises a database of warehouses, each warehouse associated with a warehouse inventory and a warehouse location, and wherein the combinator module further applies the first operational rule to the warehouses. In some embodiments, the logistics application is configured to allow an administrator to modify at least one of the first operational rule, the second operational rule, and the third operational rule in real-time, and without reprograming the server application. In some embodiments, the logistics application further comprises a dispatch module communicating the filtered delivery scheme with the best score to an administrator. In some embodiments, the logistics application further comprises a notification module communicating a delivery update in to the consumer. In some embodiments, the logistics application further comprises a scheduling module modifying the current expert schedule of at least one of the experts in real-time to include the filtered delivery scheme with the best score. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a visit location factor; an expert training factor; a visit location zone factor; a demand forecasting factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUS in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services. In some embodiments, the delivery timeslot is about 10 minutes to about 6 hours. In some embodiments, a set real-time prioritization percentage of the current expert schedule is dedicated to real-time orders. In some embodiments, the set real-time prioritization percentage is about 15% to about 50%. In some embodiments, the communication module of the server real-time mode application receives at least the items, the experts, and the MIUs from the server processor before the combinator module applies the first operational rule. In some embodiments, scheduling parallel processor is further configured to provide a backorder application comprising: a communication module receiving at least the items, the experts, and the MIUs from the server processor, and receiving the future orders from the consumer processor, wherein the item comprises an out-of-stock item or an unreleased item; a zoning module, assigning a zone to each future order based on the consumer address; and an availabilities module determining in parallel a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

Another aspect provided herein is a parallel computer-implemented multimodal method of providing high-utilization logistics for a scheduling a plurality of real-time orders and future orders within a set processing period, the method comprising: maintaining, in a computer storage, a database of items, each item associated with a skill requirement, a visit duration, a burden score, a time-of-day requirement, and a SKU; maintaining, in the computer storage, a database of experts, each expert associated with a skill proficiency and a current expert schedule; maintaining, in the computer storage, a database of one or more mobile inventory units (MIUs), each MIU associated with a stock of items, a current MIU position, and a current MIU schedule; receiving, by a computer, a real-time order and a future order from a consumer for delivery of one or more of the items to a consumer address, during a delivery timeslot, the delivery by at least one of the experts; performing a parallel real-time mode comprising: determining, by the computer, one or more possible delivery schemes by applying a first operational rule to the real-time order, the experts, and the one or more MIUs; filtering, by the computer, the one or more possible delivery schemes to select one or more filtered delivery schemes, wherein the filtering comprises applying a second operational rule to the possible delivery schemes; and scoring, by the computer, the filtered delivery schemes by applying a third operational rule to the filtered delivery schemes and determining which filtered delivery scheme has the best score; and performing a parallel future mode comprising: assigning, by the computer, a zone to each future order based on the consumer address; and determining in parallel, by the computer, a plurality of future delivery schemes for each of a plurality of future days based on the zone, the experts, the MIUs, or any combination thereof, wherein the future delivery scheme comprises a plurality of the orders within a delivery window on one of the future days; wherein the filtered delivery scheme with the best score or the future delivery scheme meets or exceeds a predetermined utilization threshold. In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, each expert in the database of experts is further associated with an expert inventory. In some embodiments, the method further comprises, maintaining, in the computer storage, a database of warehouses, each warehouse associated with a warehouse inventory and a warehouse location, wherein the combinator module further applies the first operational rule to the warehouses. In some embodiments, the method further comprises, modifying, by the computer, at least one of the first operational rule, the second operational rule, and the third operational rule in real-time by an administrator, without requiring reprograming. In some embodiments, the method further comprises, communicating, by a dispatch module, the filtered delivery scheme with the best score to an administrator. In some embodiments, the method further comprises, communicating, by a notification module, a delivery update to the consumer. In some embodiments, the method further comprises, modifying, by a scheduling module, the schedule of the selected expert in real-time to include the visit to deliver the one or more items to the consumer address. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a visit location factor; an expert training factor; a visit location zone factor; a demand forecasting factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUs in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services. In some embodiments, the delivery timeslot is about 10 minutes to about 6 hours. In some embodiments, a set real-time prioritization percentage of the current expert schedule is dedicated to real-time orders. In some embodiments, the set real-time prioritization percentage is about 15% to about 50%. In some embodiments, the method further comprises, performing a backorder mode comprising: receiving, by the computer, at least the items, the experts, and the MIUs from the server processor, and receiving the future orders from the consumer processor, wherein the item comprises an out-of-stock item or an unreleased item; assigning, by the computer, a zone to each future order based on the consumer address; and determining, in parallel, by the computer, a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

Another aspect disclosed herein are logistics platforms comprising: a client processor configured to provide a consumer application comprising: a software module presenting an interface allowing a consumer to browse and shop items; a software module presenting an interface allowing a consumer to request delivery of one or more items to a consumer address, the delivery by an expert in the one or more items; a server processor configured to provide a server application comprising: a database of items, each item associated with one or more skill requirements and a visit duration; a database of experts, each expert associated with one or more skill proficiencies and a location, each expert having a schedule; a software module identifying experts in the database of experts having skill proficiencies matching the skill requirements of the one or more items and available in a timeslot for the visit duration of the one or more items; a software module presenting timeslots, for which one or more experts are identified, to the consumer and allowing a consumer to select a timeslot; and a software module selecting an expert from among the identified experts in the selected timeslot based on shortest travel time; provided that utilization of the selected expert exceeds a predetermined utilization threshold. In some embodiments, the one or more items comprises 2, 3, 4, 5, 6, 7, 8, 9, or 10 items. In some embodiments, the software module identifying experts in the database of experts further utilizes availability for a travel time prior to the timeslot to identify experts. In further embodiments, the travel time is defaulted to 50 minutes. In some embodiments, the software module identifying experts in the database of experts further utilizes predetermined zip-to-zip travel time below a predetermined travel time threshold to identify experts. In further embodiments, the predetermined travel time threshold is 40 minutes. In some embodiments, the shortest travel time is an average of travel time from a previous location in the expert's schedule to the consumer address and from the consumer address to a next location in the expert's schedule. In some embodiments, the predetermined utilization threshold is at least three visits per day on average. In some embodiments, the server application further comprises a software module modifying the schedule of the selected expert to include the visit to deliver the one or more items to the consumer address.

In another aspect, disclosed herein are computer-implemented systems comprising: a digital processing device comprising: at least one processor, an operating system configured to perform executable instructions, a memory, and a computer program including instructions executable by the digital processing device to create a high-utilization product expert logistics application comprising: a database of items, each item associated with one or more skill requirements and a visit duration; a database of experts, each expert associated with one or more skill proficiencies and a location, each expert having a schedule; a software module receiving a request from a consumer for delivery of one or more items to a consumer address, the delivery by an expert; a software module identifying experts in the database of experts having skill proficiencies matching the skill requirements of the one or more items and available in a timeslot for the visit duration of the one or more items; a software module presenting timeslots, for which one or more experts are identified, to the consumer and allowing a consumer to select a timeslot; and a software module selecting an expert from among the identified experts in the selected timeslot based on shortest travel time; provided that utilization of the selected expert exceeds a predetermined utilization threshold. In some embodiments, the one or more items comprises 2, 3, 4, 5, 6, 7, 8, 9, or 10 items. In some embodiments, the software module identifying experts in the database of experts further utilizes availability for a travel time prior to the timeslot to identify experts. In further embodiments, the travel time is defaulted to 50 minutes. In some embodiments, the software module identifying experts in the database of experts further utilizes predetermined zip-to-zip travel time below a predetermined travel time threshold to identify experts. In further embodiments, the predetermined travel time threshold is 40 minutes. In some embodiments, the shortest travel time is an average of travel time from a previous location in the expert's schedule to the consumer address and from the consumer address to a next location in the expert's schedule. In some embodiments, the predetermined utilization threshold is at least three visits per day on average. In some embodiments, the application further comprises a software module modifying the schedule of the selected expert to include the visit to deliver the one or more items to the consumer address.

In another aspect, disclosed herein are non-transitory computer-readable storage media encoded with a computer program including instructions executable by a processor to create a high-utilization product expert logistics application comprising: a database of items, each item associated with one or more skill requirements and a visit duration; a database of experts, each expert associated with one or more skill proficiencies and a location, each expert having a schedule; a software module receiving a request from a consumer for delivery of one or more items to a consumer address, the delivery by an expert; a software module identifying experts in the database of experts having skill proficiencies matching the skill requirements of the one or more items and available in a timeslot for the visit duration of the one or more items; a software module presenting timeslots, for which one or more experts are identified, to the consumer and allowing a consumer to select a timeslot; and a software module selecting an expert from among the identified experts in the selected timeslot based on shortest travel time; provided that utilization of the selected expert exceeds a predetermined utilization threshold. In some embodiments, the one or more items comprises 2, 3, 4, 5, 6, 7, 8, 9, or 10 items. In some embodiments, the software module identifying experts in the database of experts further utilizes availability for a travel time prior to the timeslot to identify experts. In further embodiments, the travel time is defaulted to 50 minutes. In some embodiments, the software module identifying experts in the database of experts further utilizes predetermined zip-to-zip travel time below a predetermined travel time threshold to identify experts. In further embodiments, the predetermined travel time threshold is 40 minutes. In some embodiments, the shortest travel time is an average of travel time from a previous location in the expert's schedule to the consumer address and from the consumer address to a next location in the expert's schedule. In some embodiments, the predetermined utilization threshold is at least three visits per day on average. In some embodiments, the application further comprises a software module modifying the schedule of the selected expert to include the visit to deliver the one or more items to the consumer address.

In another aspect, disclosed herein are computer-implemented methods of providing high-utilization logistics for a product expert comprising: maintaining, in a computer memory, a database of items, each item associated with one or more skill requirements and a visit duration; maintaining, in a computer memory, a database of experts, each expert associated with one or more skill proficiencies and a location, each expert having a schedule; receiving, by the computer, a request from a consumer for delivery of one or more items in the database of items to a consumer address, the delivery by an expert; identifying, by the computer, experts in the database of experts having skill proficiencies matching the skill requirements of the one or more items and available in a timeslot for the visit duration of the one or more items; presenting, by the computer, timeslots for which one or more experts are identified to the consumer and allowing a consumer to select a timeslot; and selecting, by the computer, an expert from among the identified experts in the selected timeslot based on shortest travel time; provided that utilization of the selected expert exceeds a predetermined utilization threshold. In some embodiments, the one or more items comprise 2, 3, 4, 5, 6, 7, 8, 9, or 10 items. In some embodiments, identifying experts in the database of experts comprises utilizing availability for a travel time prior to the timeslot to identify experts. In further embodiments, the travel time is defaulted to 50 minutes. In some embodiments, identifying experts in the database of experts comprises utilizing predetermined zip-to-zip travel time below a predetermined travel time threshold to identify experts. In further embodiments, the predetermined travel time threshold is 40 minutes. In some embodiments, the shortest travel time is an average of travel time from a previous location in the expert's schedule to the consumer address and from the consumer address to a next location in the expert's schedule. In some embodiments, the predetermined utilization threshold is at least three visits per day on average. In some embodiments, the method further comprises modifying, by the computer, the schedule of the selected expert to include the visit to deliver the one or more items to the consumer address.

In another aspect, disclosed herein is a logistics platform comprising: a consumer processor configured to provide a consumer application comprising a software module presenting an interface allowing a consumer to browse a plurality of items and submit an order, the order comprising one or more of the plurality of items for delivery by one or more experts, a consumer address, and a delivery timeslot; and a server processor configured to provide a server application comprising: a database of items, each item associated with a skill requirement, a visit duration, a burden score, a time-of-day requirement, and a SKU; a database of experts, each expert associated with a skill proficiency, and a current expert schedule; a database of one or more mobile inventory units (MIUs), each MIU associated with a stock of items, a current MIU position, and a current MIU schedule; a combinator module applying a first operational rule to the order, the experts, and the one or more MIUs, to determine a plurality of possible delivery schemes that adhere to the first operational rule; a filter module applying a second operational rule to the plurality of possible delivery schemes, to select two or more filtered delivery schemes that adhere to the second operational rule; and a scorer module applying a third operational rule to the filtered delivery schemes, to score the filtered delivery schemes and determine which filtered delivery scheme has the best score; provided that the logistics platform is configured to meet or exceed a predetermined utilization threshold.

In some embodiments, the predetermined utilization threshold is measured in dollars of revenue/expert/minute, and wherein the predetermined utilization threshold is at least about 0.1 dollars of revenue/expert/minute to about 4 dollars of revenue/expert/minute. In some embodiments, the predetermined utilization threshold is measured in dollars of revenue/expert/minute, and wherein the predetermined utilization threshold is at least at least about 0.1 dollars of revenue/expert/minute. In some embodiments, the predetermined utilization threshold is measured in dollars of revenue/expert/minute, and wherein the predetermined utilization threshold is at least at most about 4 dollars of revenue/expert/minute. In various embodiments, the predetermined utilization threshold is measured in dollars of revenue/expert/minute, and wherein the predetermined utilization threshold is at least about 0.5 dollars of revenue/expert/minute to about 0.75 dollars of revenue/expert/minute, about 0.5 dollars of revenue/expert/minute to about 0.1 dollars of revenue/expert/minute, about 0.5 dollars of revenue/expert/minute to about 1.25 dollars of revenue/expert/minute, about 0.5 dollars of revenue/expert/minute to about 1.5 dollars of revenue/expert/minute, about 0.5 dollars of revenue/expert/minute to about 1.75 dollars of revenue/expert/minute, about 0.5 dollars of revenue/expert/minute to about 2 dollars of revenue/expert/minute, about 0.5 dollars of revenue/expert/minute to about 2.5 dollars of revenue/expert/minute, about 0.5 dollars of revenue/expert/minute to about 3 dollars of revenue/expert/minute, about 0.5 dollars of revenue/expert/minute to about 3.5 dollars of revenue/expert/minute, about 0.5 dollars of revenue/expert/minute to about 4 dollars of revenue/expert/minute, about 0.75 dollars of revenue/expert/minute to about 0.1 dollars of revenue/expert/minute, about 0.75 dollars of revenue/expert/minute to about 1.25 dollars of revenue/expert/minute, about 0.75 dollars of revenue/expert/minute to about 1.5 dollars of revenue/expert/minute, about 0.75 dollars of revenue/expert/minute to about 1.75 dollars of revenue/expert/minute, about 0.75 dollars of revenue/expert/minute to about 2 dollars of revenue/expert/minute, about 0.75 dollars of revenue/expert/minute to about 2.5 dollars of revenue/expert/minute, about 0.75 dollars of revenue/expert/minute to about 3 dollars of revenue/expert/minute, about 0.75 dollars of revenue/expert/minute to about 3.5 dollars of revenue/expert/minute, about 0.75 dollars of revenue/expert/minute to about 4 dollars of revenue/expert/minute, about 0.1 dollars of revenue/expert/minute to about 1.25 dollars of revenue/expert/minute, about 0.1 dollars of revenue/expert/minute to about 1.5 dollars of revenue/expert/minute, about 0.1 dollars of revenue/expert/minute to about 1.75 dollars of revenue/expert/minute, about 0.1 dollars of revenue/expert/minute to about 2 dollars of revenue/expert/minute, about 0.1 dollars of revenue/expert/minute to about 2.5 dollars of revenue/expert/minute, about 0.1 dollars of revenue/expert/minute to about 3 dollars of revenue/expert/minute, about 0.1 dollars of revenue/expert/minute to about 3.5 dollars of revenue/expert/minute, about 0.1 dollars of revenue/expert/minute to about 4 dollars of revenue/expert/minute, about 1.25 dollars of revenue/expert/minute to about 1.5 dollars of revenue/expert/minute, about 1.25 dollars of revenue/expert/minute to about 1.75 dollars of revenue/expert/minute, about 1.25 dollars of revenue/expert/minute to about 2 dollars of revenue/expert/minute, about 1.25 dollars of revenue/expert/minute to about 2.5 dollars of revenue/expert/minute, about 1.25 dollars of revenue/expert/minute to about 3 dollars of revenue/expert/minute, about 1.25 dollars of revenue/expert/minute to about 3.5 dollars of revenue/expert/minute, about 1.25 dollars of revenue/expert/minute to about 4 dollars of revenue/expert/minute, about 1.5 dollars of revenue/expert/minute to about 1.75 dollars of revenue/expert/minute, about 1.5 dollars of revenue/expert/minute to about 2 dollars of revenue/expert/minute, about 1.5 dollars of revenue/expert/minute to about 2.5 dollars of revenue/expert/minute, about 1.5 dollars of revenue/expert/minute to about 3 dollars of revenue/expert/minute, about 1.5 dollars of revenue/expert/minute to about 3.5 dollars of revenue/expert/minute, about 1.5 dollars of revenue/expert/minute to about 4 dollars of revenue/expert/minute, about 1.75 dollars of revenue/expert/minute to about 2 dollars of revenue/expert/minute, about 1.75 dollars of revenue/expert/minute to about 2.5 dollars of revenue/expert/minute, about 1.75 dollars of revenue/expert/minute to about 3 dollars of revenue/expert/minute, about 1.75 dollars of revenue/expert/minute to about 3.5 dollars of revenue/expert/minute, about 1.75 dollars of revenue/expert/minute to about 4 dollars of revenue/expert/minute, about 2 dollars of revenue/expert/minute to about 2.5 dollars of revenue/expert/minute, about 2 dollars of revenue/expert/minute to about 3 dollars of revenue/expert/minute, about 2 dollars of revenue/expert/minute to about 3.5 dollars of revenue/expert/minute, about 2 dollars of revenue/expert/minute to about 4 dollars of revenue/expert/minute, about 2.5 dollars of revenue/expert/minute to about 3 dollars of revenue/expert/minute, about 2.5 dollars of revenue/expert/minute to about 3.5 dollars of revenue/expert/minute, about 2.5 dollars of revenue/expert/minute to about 4 dollars of revenue/expert/minute, about 3 dollars of revenue/expert/minute to about 3.5 dollars of revenue/expert/minute, about 3 dollars of revenue/expert/minute to about 4 dollars of revenue/expert/minute, or about 3.5 dollars of revenue/expert/minute to about 4 dollars of revenue/expert/minute. In various particular embodiments, the predetermined utilization threshold is measured in dollars of revenue/expert/minute, and wherein the predetermined utilization threshold is at least about 0.5 dollars of revenue/expert/minute, about 0.75 dollars of revenue/expert/minute, about 0.1 dollars of revenue/expert/minute, about 1.25 dollars of revenue/expert/minute, about 1.5 dollars of revenue/expert/minute, about 1.75 dollars of revenue/expert/minute, about 2 dollars of revenue/expert/minute, about 2.5 dollars of revenue/expert/minute, about 3 dollars of revenue/expert/minute, about 3.5 dollars of revenue/expert/minute, or about 4 dollars of revenue/expert/minute, including increments therein.

In some embodiments, the predetermined utilization threshold is measured as a percentage of a shift of the expert that is spent with a customer, and wherein the predetermined utilization threshold is at least about 20% to about 80%. In some embodiments, the predetermined utilization threshold is measured as a percentage of a shift of the expert that is spent with a customer, and wherein the predetermined utilization threshold is at least at least about 20%. In some embodiments, the predetermined utilization threshold is measured as a percentage of a shift of the expert that is spent with a customer, and wherein the predetermined utilization threshold is at least at most about 80%. In various embodiments, the predetermined utilization threshold is measured as a percentage of a shift of the expert that is spent with a customer, and wherein the predetermined utilization threshold is at least about 20% to about 25%, about 20% to about 30%, about 20% to about 35%, about 20% to about 40%, about 20% to about 45%, about 20% to about 50%, about 20% to about 55%, about 20% to about 60%, about 20% to about 70%, about 20% to about 80%, about 25% to about 30%, about 25% to about 35%, about 25% to about 40%, about 25% to about 45%, about 25% to about 50%, about 25% to about 55%, about 25% to about 60%, about 25% to about 70%, about 25% to about 80%, about 30% to about 35%, about 30% to about 40%, about 30% to about 45%, about 30% to about 50%, about 30% to about 55%, about 30% to about 60%, about 30% to about 70%, about 30% to about 80%, about 35% to about 40%, about 35% to about 45%, about 35% to about 50%, about 35% to about 55%, about 35% to about 60%, about 35% to about 70%, about 35% to about 80%, about 40% to about 45%, about 40% to about 50%, about 40% to about 55%, about 40% to about 60%, about 40% to about 70%, about 40% to about 80%, about 45% to about 50%, about 45% to about 55%, about 45% to about 60%, about 45% to about 70%, about 45% to about 80%, about 50% to about 55%, about 50% to about 60%, about 50% to about 70%, about 50% to about 80%, about 55% to about 60%, about 55% to about 70%, about 55% to about 80%, about 60% to about 70%, about 60% to about 80%, or about 70% to about 80%. In various particular embodiments, the predetermined utilization threshold is measured as a percentage of a shift of the expert that is spent with a customer, and wherein the predetermined utilization threshold is at least about 20%, about 25%, about 30%, about 35%, about 40%, about 45%, about 50%, about 55%, about 60%, about 70%, or about 80%, including increments therein.

In some embodiments, each expert in the database of experts is further associated with an expert inventory. In some embodiments, the server application further comprises a database of warehouses, each warehouse associated with a warehouse inventory and a warehouse location, and wherein the combinator module further applies the first operational rule to the warehouses. In some embodiments, the server application is configured to allow an administrator to modify at least one of the first operational rule, the second operational rule, and the third operational rule in real-time, and without reprograming the server application. In some embodiments, at least one of the server processor and the consumer processor comprises a parallel processor. In some embodiments, the server application further comprises a dispatch module communicating the filtered delivery scheme with the best score to an administrator. In some embodiments, the server application further comprises a notification module communicating a delivery update to the consumer. In some embodiments, the server application further comprises a scheduling module modifying the current expert schedule of at least one of the experts in real-time to include the filtered delivery scheme with the best score. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a visit location factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of one or more MIUs in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services.

In another aspect, disclosed herein is a computer-implemented system comprising: a digital processing device comprising: at least one processor, an operating system configured to perform executable instructions, a memory, and a computer program including instructions executable by the digital processing device to create a high-utilization product expert logistics application comprising:

a consumer module receiving an order submitted by a consumer, the order comprising one or more items selected from a plurality of items for delivery by one or more experts, a consumer address, and a delivery timeslot; a database of items, each item associated with a skill requirement, a visit duration, a burden score, a time-of-day requirement, and a SKU; a database of experts, each expert associated with a skill proficiency and a current expert schedule; a database of one or more mobile inventory units (MIUs), each MIU associated with a stock of items, a current MIU position, and a current MIU schedule; a combinator module applying a first operational rule to the order, the experts, and the one or more MIUs, to determine a plurality of possible delivery schemes that adhere to the first operational rule; a filter module applying a second operational rule to the plurality of possible delivery schemes, to select two or more filtered delivery schemes that adhere to the second operational rule; and a scorer module applying a third operational rule to the filtered delivery schemes, to score the filtered delivery schemes and determine which filtered delivery scheme has the best score; provided that the application configured to, on average, meet or exceed a predetermined utilization threshold. In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, each expert in the database of experts is further associated with an expert inventory. In some embodiments, the logistics application further comprises a database of warehouses, each warehouse associated with a warehouse inventory and a warehouse location, and wherein the combinator module further applies the first operational rule to the warehouses. In some embodiments, the logistics application is configured to allow an administrator to modify at least one of the first operational rule, the second operational rule, and the third operational rule in real-time, and without reprograming the logistics application. In some embodiments, the logistics application further comprises a dispatch module communicating the filtered delivery scheme with the best score to an administrator. In some embodiments, the logistics application further comprises a notification module communicating a delivery update to the consumer. In some embodiments, the logistics application further comprises a scheduling module modifying the current expert schedule of at least one of the experts to include the filtered delivery scheme with the best score. In some embodiments, wherein at least one of the first operational rule, the second operational rule, and the third operational rule comprise one or more of: an item cost importance factor; an item demand factor; an item volume factor; an item promotion factor; an MIU stock factor; a warehouse stock factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUS in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services.

In another aspect, disclosed herein is a non-transitory computer-readable storage media encoded with a computer program including instructions executable by a processor to create a high-utilization product expert logistics application comprising: a consumer module receiving an order submitted by a consumer, the order comprising one or more items selected from a plurality of items for delivery by one or more experts, a consumer address, and a delivery timeslot; a database of items, each item associated with a skill requirement, a visit duration, a burden score, a time-of-day requirement, and a SKU; a database of experts, each expert associated with a skill proficiency and a current expert schedule; a database of one or more mobile inventory units (MIUs), each MIU associated with a stock of items, a current MIU position, and a current MIU schedule; a combinator module applying a first operational rule to the order, the experts, and the one or more MIUs, to determine a plurality of possible delivery schemes that adhere to the first operational rule; a filter module applying a second operational rule to the plurality of possible delivery schemes, to select two or more filtered delivery schemes that adhere to the second operational rule; and a scorer module applying a third operational rule to the filtered delivery schemes, to score the filtered delivery schemes and determine which filtered delivery scheme has the best score; provided that the application is configured to meet or exceed a predetermined utilization threshold.

In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, the processor comprises a parallel processor. In some embodiments, each expert in the database of experts is further associated with an expert inventory. In some embodiments, the logistics application further comprises a database of warehouses, each warehouse associated with a warehouse inventory and a warehouse location, and wherein the combinator module further applies the first operational rule to the warehouses. In some embodiments, the logistics application is configured to allow an administrator to modify at least one of the first operational rule, the second operational rule, and the third operational rule in real-time, and without reprograming the server application. In some embodiments, the logistics application further comprises a dispatch module communicating the filtered delivery scheme with the best score to an administrator. In some embodiments, the logistics application further comprises a notification module communicating a delivery update in to the consumer. In some embodiments, the logistics application further comprises a scheduling module modifying the current expert schedule of at least one of the experts in real-time to include the filtered delivery scheme with the best score. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously. In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUS in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services.

Another aspect provide herein is a computer-implemented method of providing high-utilization logistics for a product expert comprising: maintaining, in a computer storage, a database of items, each item associated with a skill requirement, a visit duration, a burden score, a time-of-day requirement, and a SKU; maintaining, in the computer storage, a database of experts, each expert associated with a skill proficiency and a current expert schedule; maintaining, in the computer storage, a database of one or more mobile inventory units (MIUs), each MIU associated with a stock of items, a current MIU position, and a current MIU schedule; receiving, by a computer, an order from a consumer for delivery of one or more of the items to a consumer address, during a delivery timeslot, the delivery by at least one of the experts; determining, by the computer, one or more possible delivery schemes by applying a first operational rule to the order, the experts, and the one or more MIUs; filtering, by the computer, the one or more possible delivery schemes to select one or more filtered delivery schemes, wherein the filtering comprises applying a second operational rule to the possible delivery schemes; and scoring, by the computer, the filtered delivery schemes by applying a third operational rule to the filtered delivery schemes and determining which filtered delivery scheme has the best score; wherein the filtered delivery scheme with the best score meets or exceeds a predetermined utilization threshold.

In some embodiments, the predetermined utilization threshold is measured as dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, each expert in the database of experts is further associated with an expert inventory. Some embodiments further comprise maintaining, in the computer storage, a database of warehouses, each warehouse associated with a warehouse inventory and a warehouse location, wherein the combinator module further applies the first operational rule to the warehouses. Some embodiments further comprise, modifying, by the computer, at least one of the first operational rule, the second operational rule, and the third operational rule in real-time by an administrator, without requiring reprograming. Some embodiments further comprise communicating, by a dispatch module, the filtered delivery scheme with the best score to an administrator. Some embodiments further comprise communicating, by a notification module, a delivery update to the consumer. Some embodiments further comprise, modifying, by a scheduling module, the schedule of the selected expert in real-time to include the visit to deliver the one or more items to the consumer address. In some embodiments, at least one of the first operational rule, the second operational rule, and the third operational rule comprise one or more of: an item cost importance factor; an item demand factor; an item volume factor; an item promotion factor; an MIU stock factor; a warehouse stock factor; a travel time importance factor; a specific expert utilization factor; and an order split-ability factor. In some embodiments, at least one of the combinator module applying the first operational rule, the filter module applying a second operational rule, and the scorer module applying the third operational rule occurs continuously In some embodiments, at least one of the combinator module applying the first operational rule, the filter module applying a second operational rule, and the scorer module applying the third operational rule occurs periodically. In some embodiments, at least one of the combinator module applying the first operational rule, the filter module applying a second operational rule, and the scorer module applying the third operational rule occurs after a set number of orders. In some embodiments, the server application is capable of updating at least one of the database of items, the database of experts and the database of MIUS in real-time. In some embodiments, the server application further comprises an MIU stocking module applying a fourth operational rule to at least one of the database of items, the database of experts, and the database of one or more MIUs, to determine an MIU inventory for one or more of the MIUs that adheres to the fourth operational rule. In some embodiments, each item is further associated with one or more add-on items or services.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a non-limiting example of a process flow diagram; in this case, a diagram illustrating an exemplary end user experience;

FIG. 2 shows a non-limiting example of a process flow diagram; in this case, a diagram illustrating a first exemplary process for identifying time slots wherein an expert is available to deliver a one or more identified products to an identified meeting address and wherein expert utilization is maximized;

FIG. 3 shows a non-limiting example of a process flow diagram; in this case, a diagram illustrating a first exemplary process for creating a visit event wherein available experts are identified to deliver a one or more identified products to an identified meeting address and wherein the best expert selected to maximize utilization;

FIG. 4 shows a non-limiting example of a process flow diagram; in this case, a diagram illustrating a second exemplary process for identifying time slots wherein an expert is available to deliver a one or more identified products to an identified meeting address and wherein expert utilization is maximized;

FIG. 5 shows a non-limiting example of a process flow diagram; in this case, a diagram illustrating a second exemplary process for creating a visit event wherein available experts are identified to deliver a one or more identified products to an identified meeting address and wherein the best expert selected to maximize utilization;

FIG. 6 shows a non-limiting example of a process flow diagram; in this case, a diagram illustrating a third exemplary process for creating a visit event wherein available experts are identified to deliver a one or more identified products to an identified meeting address and wherein the best expert selected to maximize utilization;

FIG. 7 shows a non-limiting example of a user interface; in this case, an interface offering a particular product and including interface elements allowing a user to request expert delivery of the product and refine a date/time estimate for delivery by entering their zip code;

FIG. 8 shows a non-limiting example of a user interface; in this case, an interface offering a particular product and including interface elements allowing a user to request expert delivery of the product and refine a date/time estimate for delivery by entering their zip code;

FIG. 9 shows a non-limiting example of a user interface; in this case, an interface offering a particular product and offering expert delivery by a particular date and time;

FIG. 10 shows a non-limiting example of a user interface; in this case, an interface offering a particular product, offering expert delivery by a particular date and time, and including interface elements allowing the user to review alternative available expert delivery dates and times;

FIG. 11 shows a non-limiting example of a process flow diagram; in this case, a diagram illustrating a fourth exemplary process for determining, filtering, and scoring delivery schemes wherein each delivery scheme comprises an expert delivering one or more identified products to a consumer address, and wherein expert utilization is maximized;

FIG. 12 shows a non-limiting example of multiple possible delivery schemes; in this case, wherein the possible delivery schemes are determined by a combinator module of the fourth exemplary process;

FIG. 13 shows a non-limiting example of filtered delivery schemes; in this case, wherein the filtered delivery schemes are determined by a filter module of the fourth exemplary process;

FIG. 14 shows a non-limiting example of delivery scheme scores; in this case, wherein the delivery scheme scores are determined by a scorer module of the fourth exemplary process;

FIG. 15 shows a non-limiting example of a process flow diagram; in this case, a diagram illustrating parallel processing to simultaneously determine, filter and score multiple delivery schemes;

FIG. 16 shows a non-limiting example of a process flow diagram; in this case, a diagram illustrating the service levels and modes of service;

FIG. 17 shows a non-limiting example of a session overlap chart; in this case, a chart optimizing the number of scheduled orders;

FIG. 18 shows a non-limiting example of an overlap probability chart; in this case, a chart optimizing the MIU inventory;

FIG. 19 shows a non-limiting example of an order timeslot table;

FIG. 20 shows a non-limiting example of a parallel processor;

FIG. 21 shows a non-limiting example of a digital processing device; in this case, a device with one or more CPUs, a memory, a communication interface, and a display;

FIG. 22 shows a non-limiting example of a web/mobile application provision system; in this case, a system providing browser-based and/or native mobile user interfaces; and

FIG. 23 shows a non-limiting example of a cloud-based web/mobile application provision system; in this case, a system comprising an elastically load balanced, auto-scaling web server and application server resources as well synchronously replicated databases.

### DETAILED DESCRIPTION OF THE DRAWINGS

Described herein, in certain embodiments, are logistics platforms comprising: a client processor configured to provide a consumer application comprising: a software module presenting an interface allowing a consumer to browse and shop items; a software module presenting an interface allowing a consumer to request delivery of one or more items to a consumer address, the delivery by an expert in the one or more items; a server processor configured to provide a server application comprising: a database of items, each item associated with one or more skill requirements and a visit duration; a database of experts, each expert associated with one or more skill proficiencies and a location, each expert having a schedule; a software module identifying experts in the database of experts having skill proficiencies matching the skill requirements of the one or more items and available in a timeslot for the visit duration of the one or more items; a software module presenting timeslots, for which one or more experts are identified, to the consumer and allowing the consumer to select a timeslot; and a software module selecting an expert from among the identified experts in the selected timeslot based on shortest travel time; provided that utilization of the selected expert exceeds a predetermined utilization threshold.

Also described herein, in certain embodiments, are computer-implemented systems comprising: a digital processing device comprising: at least one processor, an operating system configured to perform executable instructions, a memory, and a computer program including instructions executable by the digital processing device to create a high-utilization product expert logistics application comprising: a database of items, each item associated with one or more skill requirements and a visit duration; a database of experts, each expert associated with one or more skill proficiencies and a location, each expert having a schedule; a software module receiving a request from a consumer for delivery of one or more items to a consumer address, the delivery by an expert; a software module identifying experts in the database of experts having skill proficiencies matching the skill requirements of the one or more items and available in a timeslot for the visit duration of the one or more items; a software module presenting timeslots, for which one or more experts are identified, to the consumer and allowing the consumer to select a timeslot; and a software module selecting an expert from among the identified experts in the selected timeslot based on shortest travel time; provided that utilization of the selected expert exceeds a predetermined utilization threshold

Also described herein, in certain embodiments, are non-transitory computer-readable storage media encoded with a computer program including instructions executable by a processor to create a high-utilization product expert logistics application comprising: a database of items, each item associated with one or more skill requirements and a visit duration; a database of experts, each expert associated with one or more skill proficiencies and a location, each expert having a schedule; a software module receiving a request from a consumer for delivery of one or more items to a consumer address, the delivery by an expert; a software module identifying experts in the database of experts having skill proficiencies matching the skill requirements of the one or more items and available in a timeslot for the visit duration of the one or more items; a software module presenting timeslots, for which one or more experts are identified, to the consumer and allowing the consumer to select a timeslot; and a software module selecting an expert from among the identified experts in the selected timeslot based on shortest travel time; provided that utilization of the selected expert exceeds a predetermined utilization threshold.

Also described herein, in certain embodiments, are computer-implemented methods of providing high-utilization logistics for a product expert comprising: maintaining, in a computer memory, a database of items, each item associated with one or more skill requirements and a visit duration; maintaining, in a computer memory, a database of experts, each expert associated with one or more skill proficiencies and a location, each expert having a schedule; receiving, by the computer, a request from a consumer for delivery of one or more items in the database of items to a consumer address, the delivery by an expert; identifying, by the computer, experts in the database of experts having skill proficiencies matching the skill requirements of the one or more items and available in a timeslot for the visit duration of the one or more items; presenting, by the computer, timeslots for which one or more experts are identified to the consumer and allowing the consumer to select a timeslot; and selecting, by the computer, an expert from among the identified experts in the selected timeslot based on shortest travel time; provided that utilization of the selected expert exceeds a predetermined utilization threshold.

### Terms and Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 10%, 5%, or 1%, including increments therein.

### End User Experience

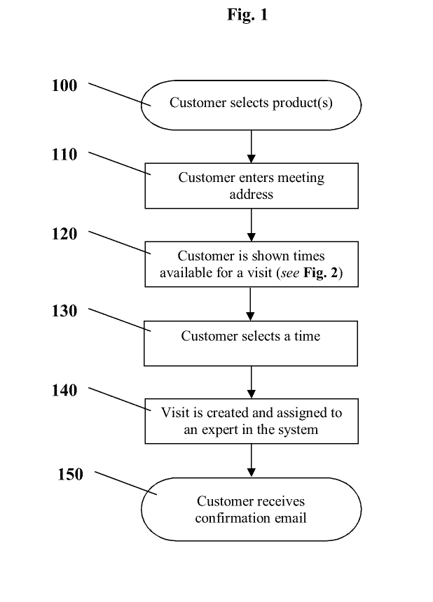

FIG. 1 shows a non-limiting example of a process flow diagram illustrating an exemplary end user experience comprising the customer selecting a product 100, the customer entering a meeting address 110, the customer being shown times available for a visit 120, the customer selecting a time 130, a visit being created and assigned to an expert in the system 140, and the customer receiving a confirmation email 150. In some embodiments, the customer selecting a product 100 comprises the customer selecting a product from a plurality of products. In some embodiments, the customer entering a meeting address 110 comprises the customer entering a street address, the customer selecting a stored address, or any combination thereof. In some embodiments, the customer being shown times available for a visit 120 comprises the customer being shown a visit start time, a visit start time variance, a visit star timeslot, or any combination thereof. In some embodiments, the customer receiving a confirmation email 150 comprises the customer receiving a confirmation email comprising the product, the time, the address, or any combination thereof.

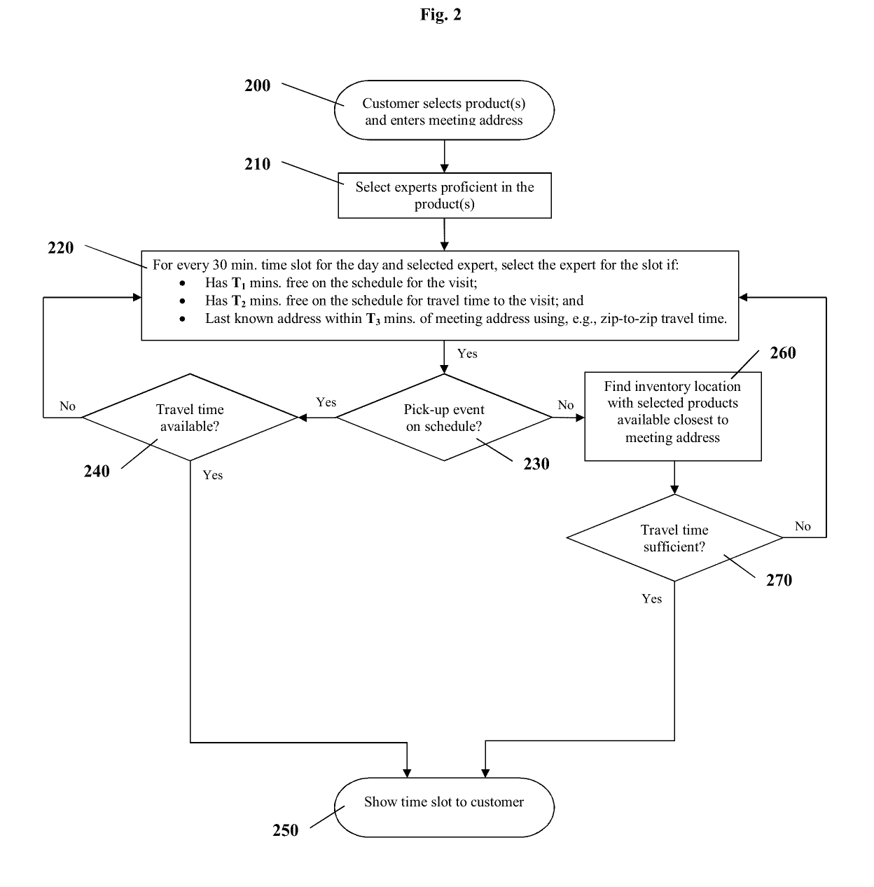

FIG. 2 shows a non-limiting example of a process flow diagram illustrating a first exemplary process for identifying time slots wherein an expert is available to deliver a one or more identified products to an identified meeting address. In some embodiments the process comprises the customer selecting a product and entering a meeting address 200, selecting an expert proficient in the product 210, determining an expert availability for every 30 minute time slot in the day 220, showing the time slot to the customer 250 if an expert is available, if the expert has a pick-up event on schedule 230, and if there is sufficient travel time for the expert to travel to the address 240. In some embodiments, if a pick-up event is not on the schedule 230, an inventory location close to the meeting address is determined 260, and there is sufficient travel time for the expert to travel to the address 270, the time slot is shown to the customer 250. In some embodiments the expert is selected to maximize expert utilization.

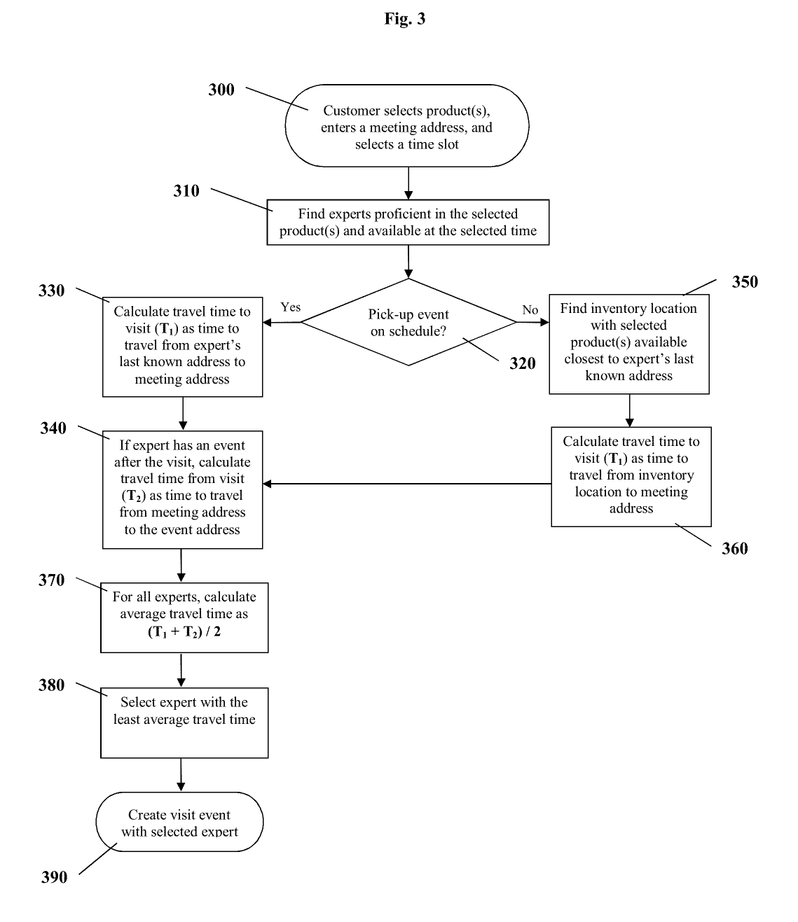

FIG. 3 shows a non-limiting example of a process flow diagram of a first exemplary process for creating a visit event comprising a customer selecting a product, a meeting address and a time slot 300, finding experts proficient in the selected products and available at the selected times and determining if the expert has a pick-up event on schedule 320. For each expert, if the expert does not have a pick-up event on schedule 320, finding an inventory location with the selected product that is closest to the expert's last known address 350, calculating a travel time as the time from the inventory location to the meeting address (T1) 360, calculating a travel time to the expert's next meeting address (T2) 340, and averaging T1 and T2 to determine an average travel time 370. For each expert, if the expert does has a pick-up event on schedule 320, calculating a travel time as the time from the inventory location to the meeting address (T1) 340, calculating a travel time to the expert's next meeting address (T2) 340, and averaging T1 and T2 to determine an average travel time 370. Once the average travel times are calculated for each expert, the expert with the least average travel time is selected 380, and a visit event with the selected expert is created 390. In some embodiments, available experts are identified to deliver a one or more identified products to an identified meeting address and wherein the best expert selected to maximize utilization.

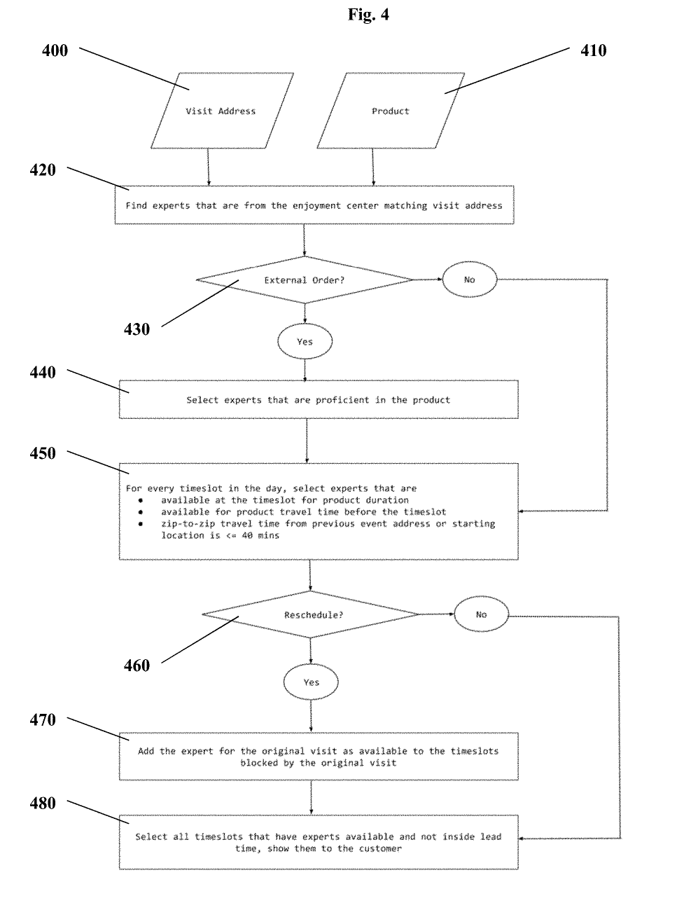

FIG. 4 shows a non-limiting example of a process flow diagram illustrating a second exemplary process for identifying time slots comprising receiving a visit address 400 and a product 410, and determining experts from an enjoyment center matching the visit address 420 selecting an expert that is proficient in the product 440 if the order is external 430, selecting available experts 450, if rescheduling is required 460, marking the original expert as available during the originally scheduled meeting, and selecting and displaying all experts to the customer that are available 480. In some embodiments, the second exemplary process for identifying time slots maximizes expert utilization.

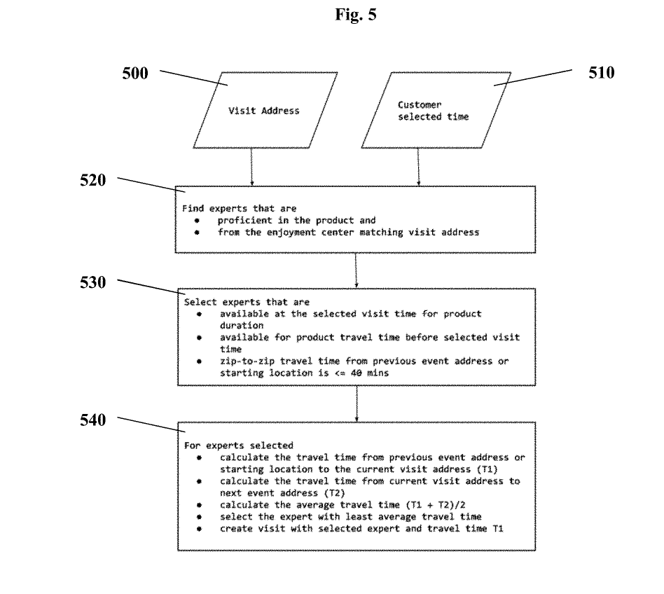

FIG. 5 shows a non-limiting example of a process flow diagram illustrating a second exemplary process for creating a visit event comprising receiving a visit address 500 and a customer selected time 510, finding experts that are proficient in the product and from the enjoyment center matching the visit address 520, selecting experts that are available at the selected visit time for a product, and for product travel time before the selected visit time, and have a zip-to-zip travel time of less than 40 minutes 530, calculating and selecting an expert with the least average travel time and creating a visit with the selected expert and travel time 540. In some embodiments the average travel time is calculated as the average of the travel time between the expert's previous address and the selected address, and the average time from the selected address to the next event address. In some embodiments, the second exemplary process for creating a visit event maximizes expert utilization.

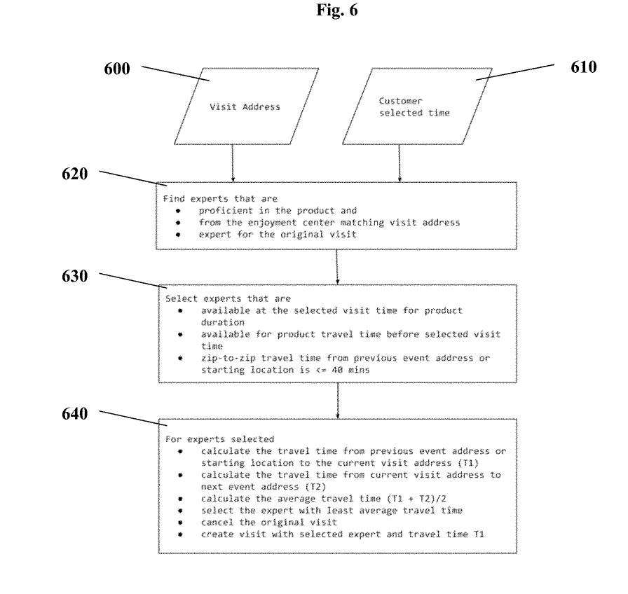

FIG. 6 shows a non-limiting example of a process flow diagram illustrating a third exemplary process for creating a visit event receiving a visit address 600 and a customer selected time 610, finding experts that are proficient in the product, from the enjoyment center matching the visit address, or are the expert from the original visit 620, selecting experts that are available at the selected visit time for a product, and for product travel time before the selected visit time, and have a zip-to-zip travel time of less than 40 minutes 630, calculating and selecting an expert with the least average travel time, canceling the original visit, and creating a visit with the selected expert and travel time 640. In some embodiments the average travel time is calculated as the average of the travel time between the expert's previous address and the selected address, and the average time from the selected address to the next event address. In some embodiments, the second exemplary process for creating a visit event maximizes expert utilization

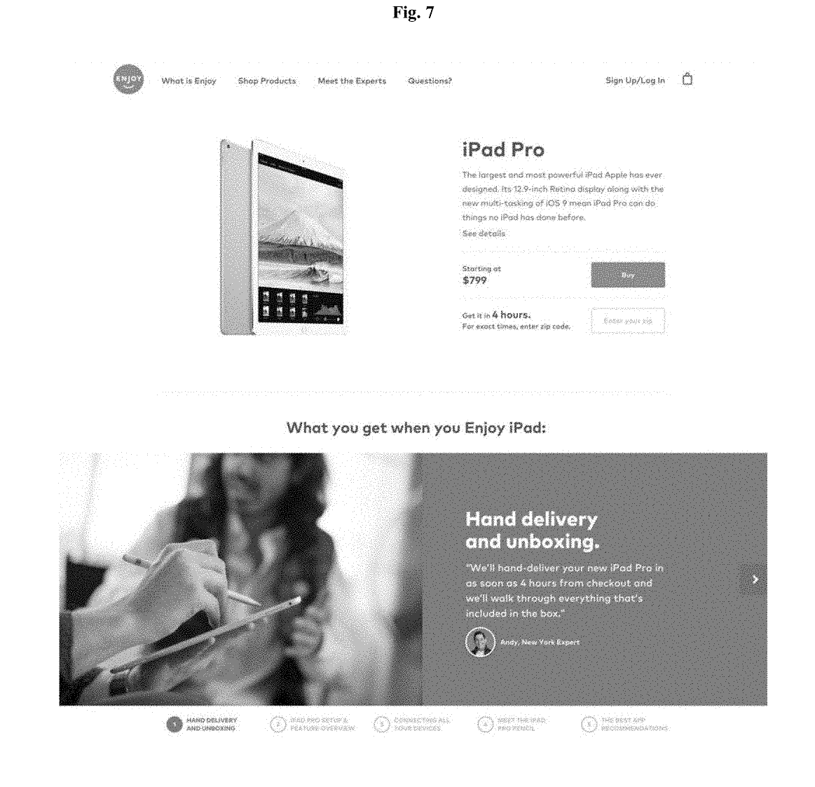

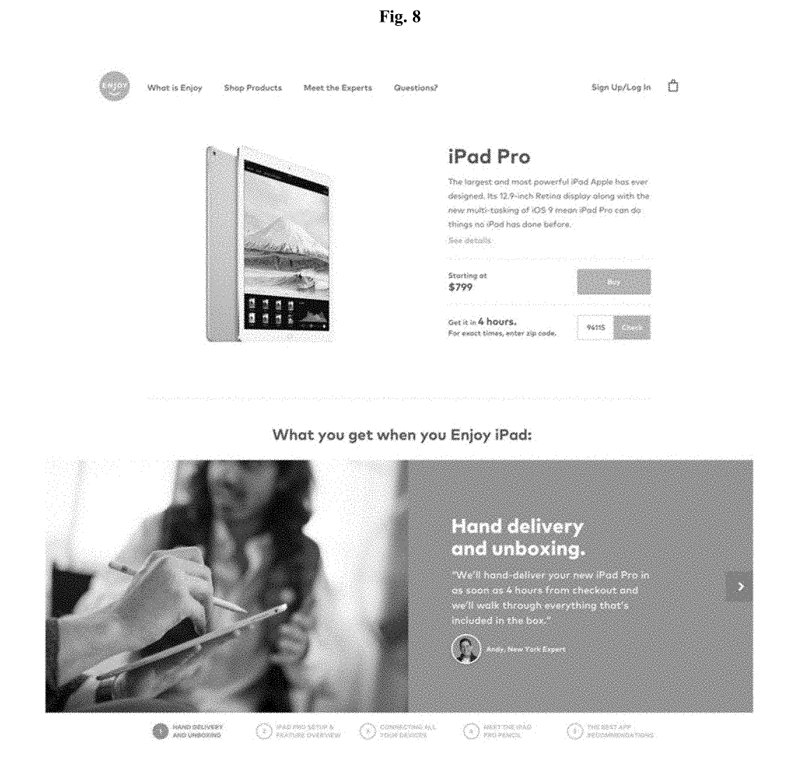

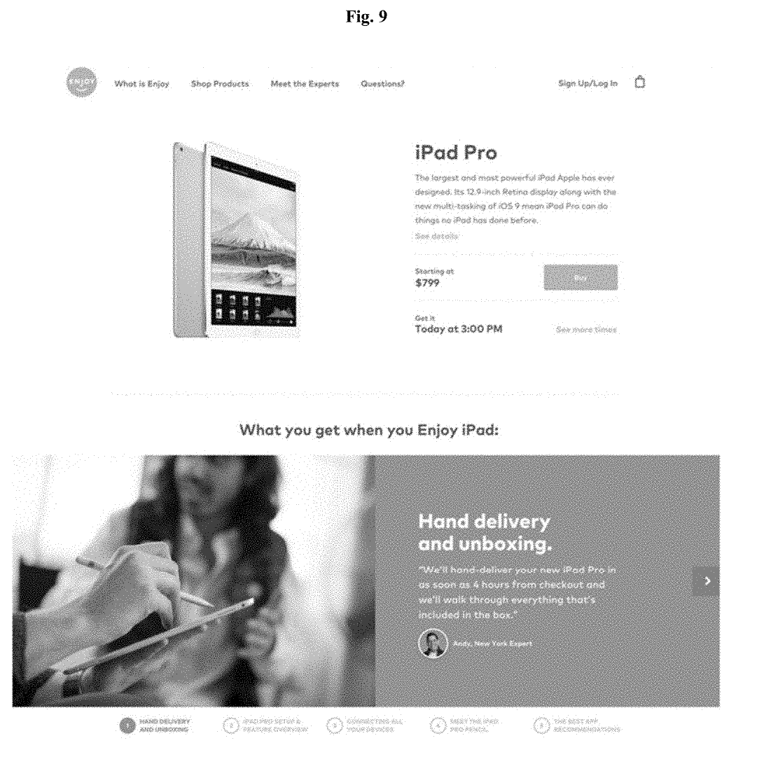

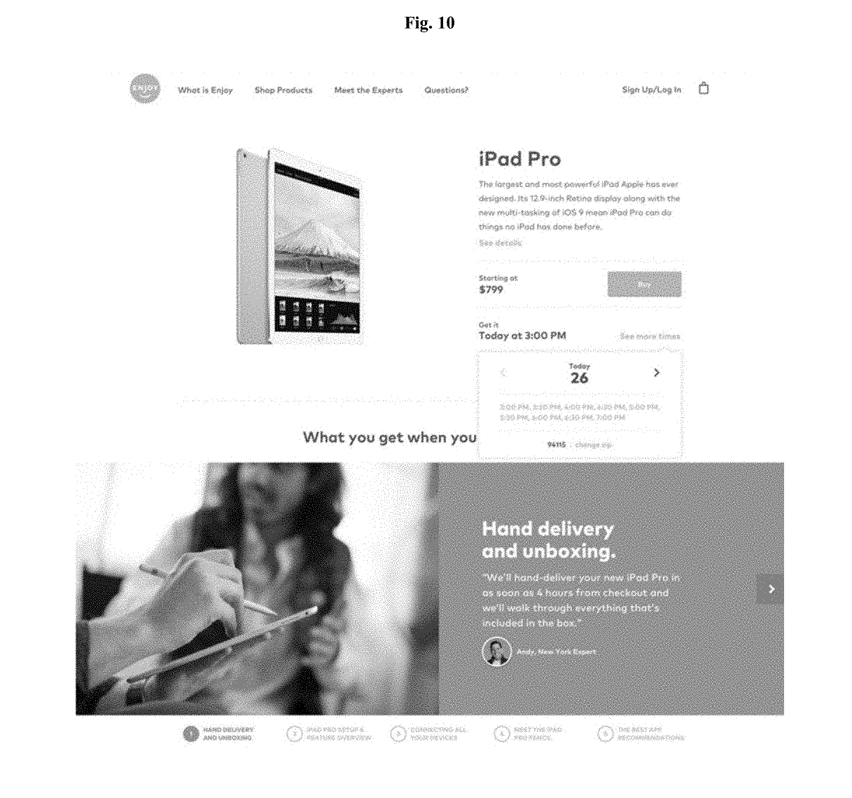

FIGS. 7 and 8 show a non-limiting example of a user interface offering a particular product and including interface elements allowing a user to request expert delivery of the product and refine a date/time estimate for delivery by entering their zip code. FIG. 9 shows an additional non-limiting example of a user interface offering a particular product and offering expert delivery by a particular date and time. FIG. 10 shows a non-limiting example of a user interface offering a particular product, offering expert delivery by a particular date and time, and including interface elements allowing the user to review alternative available expert delivery dates and times.

### Server Application

In some embodiments, the platforms, systems, media, and methods described herein include a server application comprising a database of items, a database of experts, a database of MIUs, a combinator module applying a first operational rule, a filter module applying a second operational rule, and a scorer module applying a third operational rule.

In some embodiments, the server application is capable of updating at least one of the database of items, the database of experts and the database of one or more MIUs in real-time.

In some embodiments, at least one of the combinator module applying the first operational rule, the filter module applying a second operational rule, and the scorer module applying the third operational rule occurs continuously, periodically, or after a set number of orders.

In some embodiments, the server application further comprises a dispatch module communicating the filtered delivery scheme with the best score to an administrator. In some embodiments, the server application further comprises a notification module communicating a delivery update to the consumer. In some embodiments, the server application further comprises a scheduling module modifying the current expert schedule of at least one of the experts in real-time to include the filtered delivery scheme with the best score.

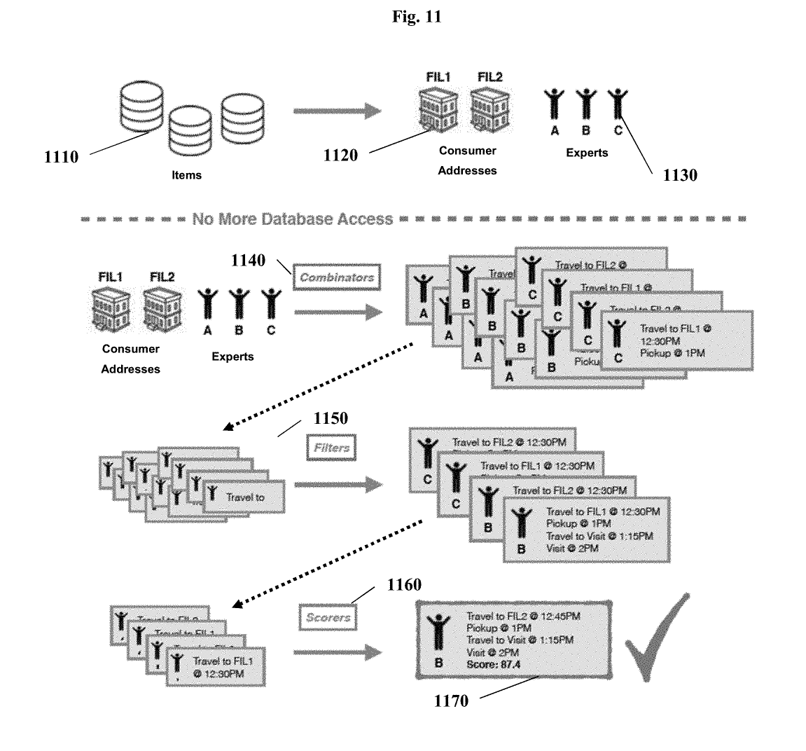

FIG. 11 shows a non-limiting example of a process flow diagram illustrating a fourth exemplary process for determining, filtering, and scoring delivery schemes comprising receiving a database of items 1110, a database of consumer addresses 1120, and a database of experts 1130, determining, by a combinator module, a plurality of possible delivery schemes 1140, selecting, by a filter module, two or more filtered delivery schemes, and determining, by a scorer module, which filtered delivery scheme has the best score. In some embodiments, the fourth exemplary process for determining, filtering, and scoring delivery schemes maximizes expert utilization.

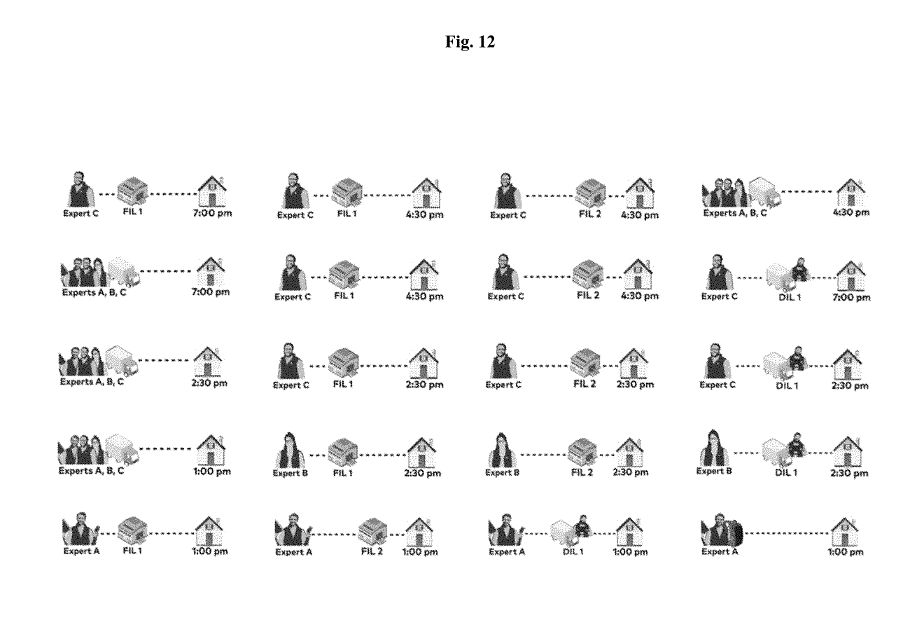

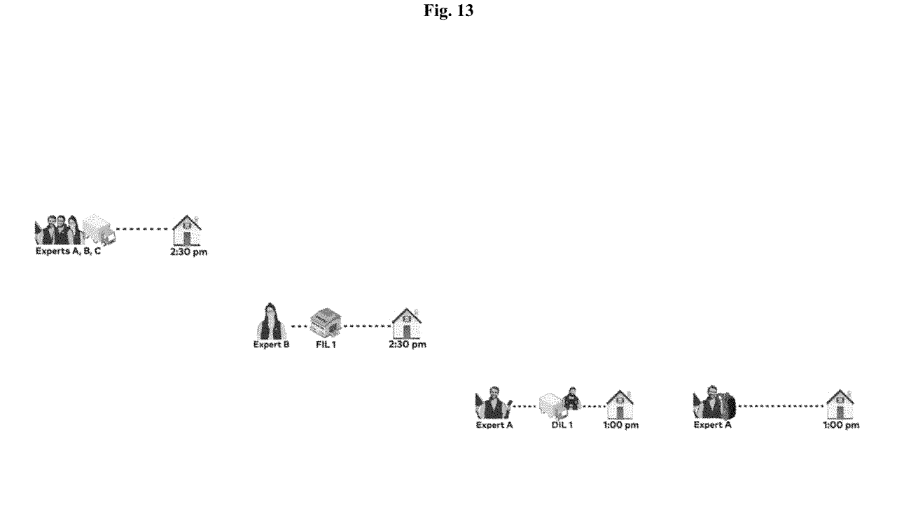

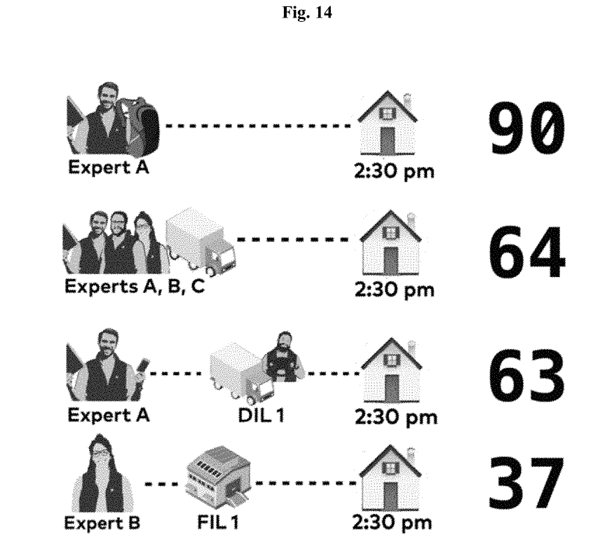

FIG. 12 shows a non-limiting example of multiple possible delivery schemes determined by a combinator module of the fourth exemplary process. FIG. 13 shows a non-limiting example of filtered delivery schemes determined by a filter module of the fourth exemplary process. FIG. 14 shows a non-limiting example of delivery scheme scores determined by a scorer module of the fourth exemplary process.

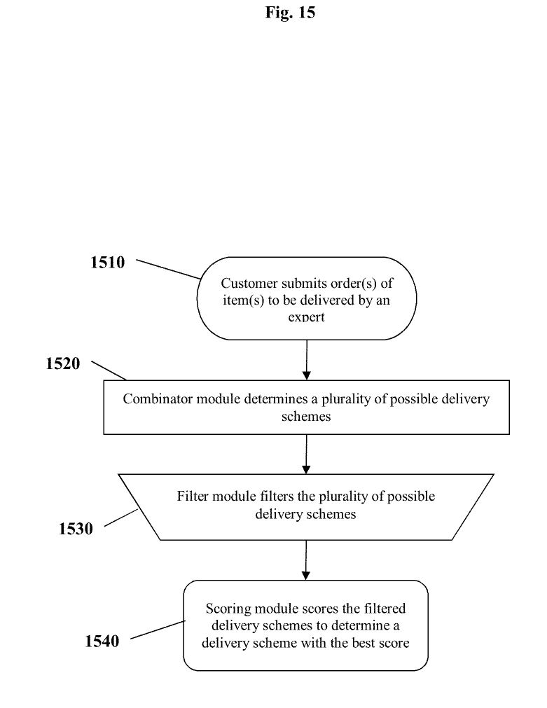

FIG. 15 shows a non-limiting example of a process flow diagram illustrating parallel processing to simultaneously determine, filter, and score multiple delivery schemes comprising the customer submitting an order of items to be delivered by an expert 1510, a combinator module determining a plurality of possible delivery schemes 1520, a filter module filters the plurality of possible delivery schemes 1530, and a scoring module scoring the filtered delivery schemes to determine a delivery scheme with the best score 1540.

In some embodiments, the parallel processor comprises a distributed computing parallel processor. In some embodiments, the distributed computing parallel processor conducts a distributed parallel process among multiple cores in a plurality of servers, which enables a much higher horizontal parallelism than calculation of all threads on multiple cores of a single server. In some cases, at least two of the multiple cores reside in a single facility. In some cases, at least two of the multiple cores reside in distinct facilities. In some cases, at least two of the servers reside in a single facility. In some cases, at least two of the servers reside in distinct facilities. Further, such a computing architecture is capable of employing additional servers on demand to maintain consistent throughput and response times during volume and computational load surges. Additionally, distributed parallel computing allows for improved calculation times based on the amount of parallelism required to achieve a specific result. Finally, distributed parallel processing allows multiple streams of calculation to be performed in the same time as a single calculation thread to improve performance of the server application(s).

In some embodiments, all the data required for calculations are pre-loaded into one or more local memory devices prior to starting the calculations. In such embodiments, queries to databases are not needed once the calculations are begun and I/O operations are halted with regard to the databases (and optionally resumed upon completion of the calculations) to improve performance of the server application(s).

### Multimodal Parallel Logistics Platforms, Systems, and Methods

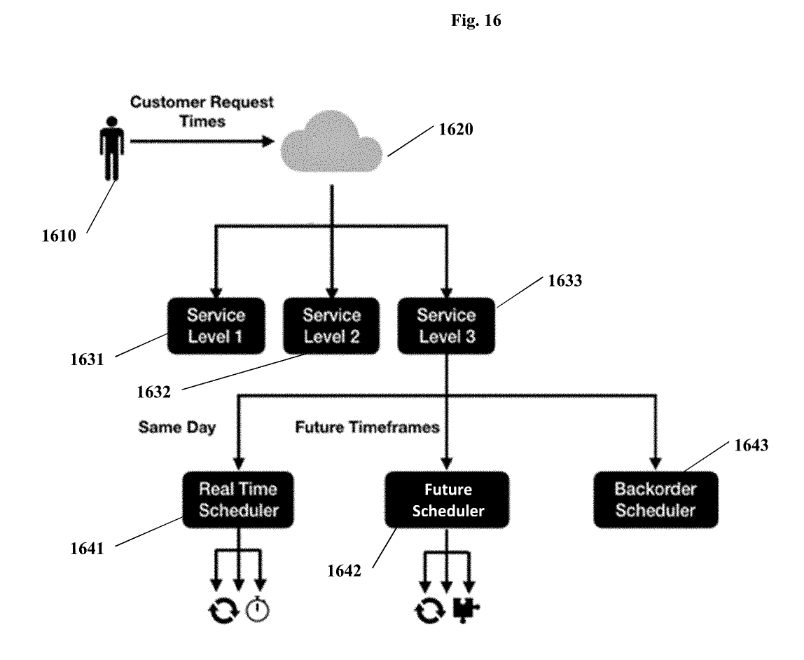

FIG. 16 shows a non-limiting example of a process flow diagram illustrating parallel processing to schedule a plurality of real-time orders and future orders within a set processing period. The set processing period may be 0.001, 0.005, 0.01, 0.05, 0.1, 0.5, 1, 2, 3, 4, 5, 6, 7, 8, 9, 10, 12, 14, 16, 18, 20, or more milliseconds including increments therein. The very short set processing period enabled by the disclosure herein allows for near-instantaneous scheduling. Such near-instantaneous scheduling retains consumer's concentration and patience for better and more efficient service. As described below, the parallel distributed computing platforms, methods, systems, and media are specifically configured and designed to achieve such a low and beneficial processing period.

As seem, the platform may comprise a consumer processor 1610 configured to allow a consumer to submit a real-time order and a future order; a server processor 1620 configured to provide a server application, and a scheduling parallel processor 1641 1642 1643.

The server application may comprise a database of items, a database of experts, and a database of one or more mobile inventory units (MIUs). Each item may be associated with a skill requirement, a visit duration, a burden score, a time-of-day requirement, and a SKU. Each expert may be associated with a skill proficiency, and a current expert schedule. Each MIU may be associated with a stock of items, a current MIU position, and a current MIU schedule.

The scheduling parallel processor 1641 1642 1643 may be configured to provide a server real-time mode application 1641 and a server future mode application 1642. In some embodiments, scheduling parallel processor is further configured to provide a backorder application 1643. The multimodal scheduling parallel processor may comprise 2, 3, 4, 5, 6, 7, 8, 9, 10, or more modes. The scheduling parallel processors 1641 1642 1643 available to a consumer may depend on a service level 1631 1632 1633 associated with the consumer. A consumer with Service Level 1 1631 may be allowed to employ only the future scheduler 1642. A consumer with Service Level 2 1632 may be allowed to employ only the future scheduler 1642 and the real-time scheduler 1641. As seen, a consumer with Service Level 3 1633 may be allowed to employ the real-time scheduler 1641, the future scheduler 1642, and the backorder scheduler 1643. A consumer with Service Level 1 1631 may be allowed to employ one or more of the real-time scheduler 1641, the future scheduler 1642, and the backorder scheduler 1643. A consumer with Service Level 2 1632 may be allowed to employ one or more of the real-time scheduler 1641, the future scheduler 1642, and the backorder scheduler 1643. A consumer with Service Level 3 1633 may be allowed to employ one or more of the real-time scheduler 1641, the future scheduler 1642, and the backorder scheduler 1643.

The scheduling parallel processor 1641 1642 1643 may determine the filtered real-time delivery, the future delivery scheme, the backorder delivery scheme, or any combination thereof for each day by forming a parallel branched graph that is aggregated by parent nodes, wherein each branch contains about 1800 combinations. Each branch may contain 900, 1,000, 1,100, 1,200, 1,300, 1,400, 1,500, 1,600, 1,700, 1,800, 2,000, 2,500, 3,000, 4,000, or more combinations including increments therein. The combinations in each branch may be processed in about 10 milliseconds. The combinations in each branch may be processed in about 1, 2, 3, 4, 5, 6, 7, 8, 9, 10, 12, 14, 16, 18, 20, or more milliseconds including increments therein. The system may be configured to optimize response time over further calculations required to determine a more ideal delivery scheme. As such, calculations within a particular branch may be terminated after exhaustive timeout period, whereafter the branch is considered to have no solution.

The logistics platform is configured to meet or exceed a predetermined utilization threshold.

### Real-Time Orders and Modes

The real-time order may comprise one or more of the plurality of items for delivery by one or more experts, a consumer address, and a delivery timeslot. The real-time order may comprise a same-day order, or a next-day order.

The server real-time mode application 1641 may comprise a communication module, a combinator module, a filter module, and a scorer module.

The communication module may receive at least the items, the experts, and the MIUs from the server processor. The communication module may further or alternatively receive the real-time orders from the consumer processor.

The combinator module may apply a first operational rule in parallel to the real-time orders, the experts, and the one or more MIUs. The combinator module may apply a first operational rule in parallel to the real-time orders, the experts, and the one or more MIUs based on the real-time order. The combinator module may apply a first operational rule in parallel to the real-time orders, the experts, and the one or more MIUs based on the real-time order to determine a plurality of real-time delivery schemes that adhere to the first operational rule. The combinator module may apply a first operational rule in parallel to the real-time orders for each delivery time slot. In some embodiments, the delivery timeslot is about 10 minutes to about 360 minutes.

In some embodiments, the communication module of the server real-time mode application receives at least the items, the experts, and the MIUs from the server processor before the combinator module applies the first operational rule. Such an implement reduces the amount of data received by the communication module, as the plurality of real-time delivery schemes may contain more information than the received items, experts, and MIUs. As server fees correlate to the amount of data transferred therein or therefrom, reduced data transmission enables reduced operational costs.

The filter module may apply a second operational rule to the plurality of real-time delivery schemes. The filter module may apply a second operational rule to the plurality of real-time delivery schemes to select two or more filtered real-time delivery schemes. The filter module may apply a second operational rule to the plurality of real-time delivery schemes to select two or more filtered real-time delivery schemes that adhere to the second operational rule.

The scorer module may apply a third operational rule to the filtered real-time delivery schemes. The scorer module may apply a third operational rule to the filtered real-time delivery schemes to score the filtered real-time delivery schemes. The scorer module may apply a third operational rule to the filtered real-time delivery schemes to score the filtered real-time delivery schemes and determine which filtered real-time delivery scheme has the best score.

In some embodiments, a set real-time prioritization percentage of the current expert schedule is dedicated to real-time orders. In some embodiments, the set real-time prioritization percentage is about 15% to about 50%. The set real-time prioritization percentage may be dependent on the zone the expert is assigned to, a current real-time demand in a zone, a historical real-time demand in a zone, a current future demand in a zone, a historical future demand in a zone, or any combination thereof.

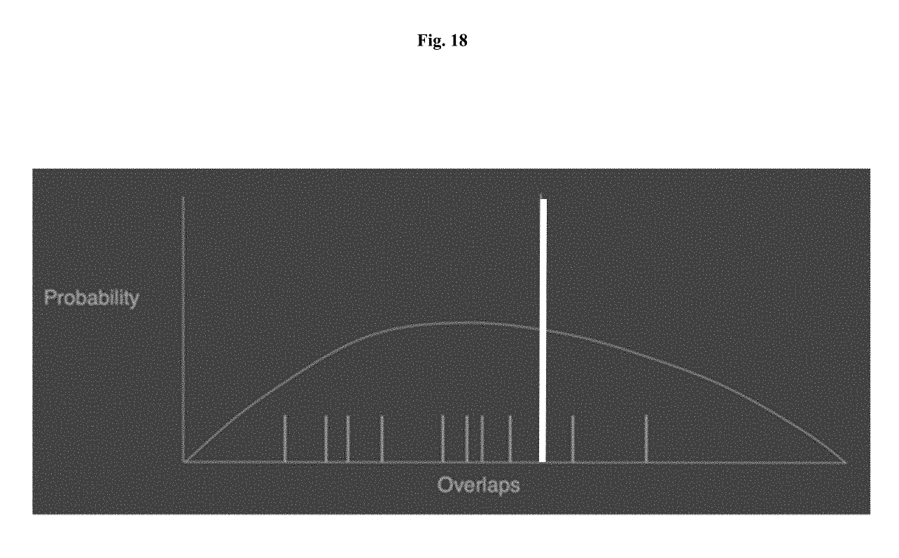

In some embodiments, at least of the first operational rule and the second operational rule comprises a demand forecasting factor. The demand forecasting factor may correlate to a quantity of a certain item within one or more of the MIUs required to enable same day availability. In some embodiments, the demand forecasting factor is determined by calculating probability distributions from historical orders over a number of prior days. Each historical order and probability distribution may be associated with a specific geographical zone. The demand forecasting factor may further correlate with operational constraints, such as the number of MIUs in a zone and the capacity of each MIU. FIG. 18 shows a non-limiting example of an overlap probability chart.

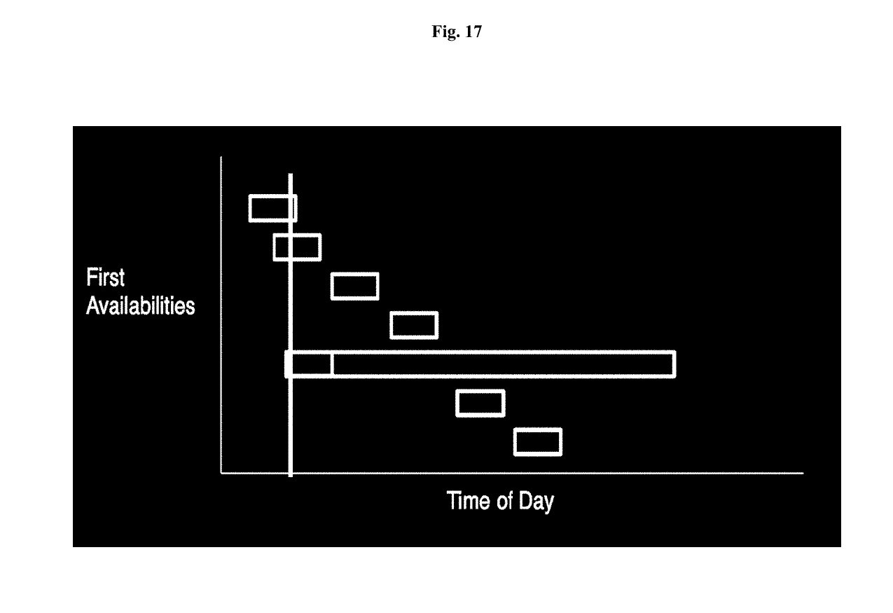

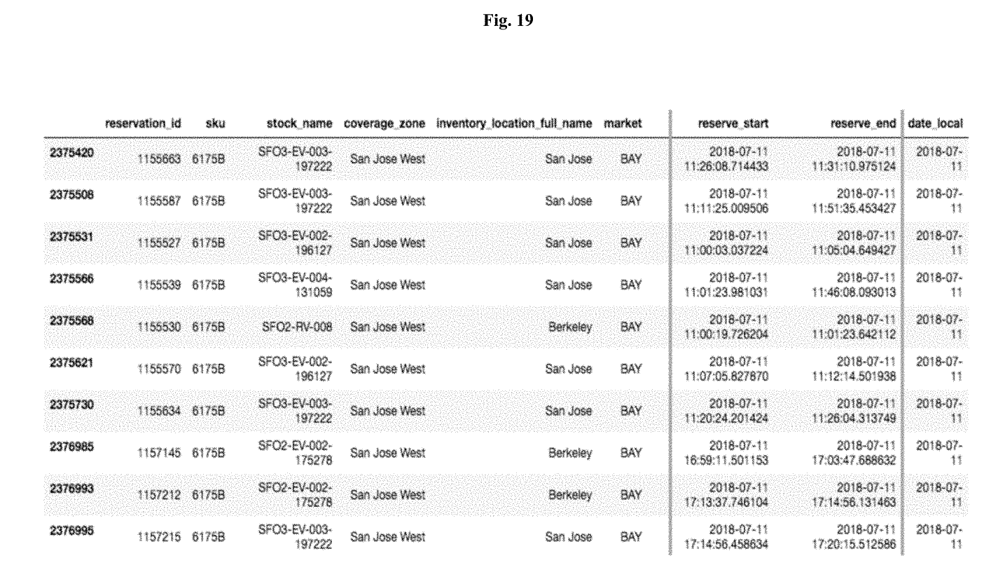

FIG. 17 shows a non-limiting example of a session overlap chart. In some embodiments, time-overlapping requests are considered for items in each zone. If all future orders for X number of an item in an MIU are fulfilled, then X number of items should be stocked within each MIU. However, the prediction of additional real-time demand ensures proper stock within each MIU of each item to fulfil real-time order demand. The additional stock of each item may be associated with a confidence level corresponding to the ratio between the risks associated with overstocking and understocking that item. The real-time order demand may be associated with an expected conversion factor based on how many orders are not actually fulfilled due to customer cancelations or order changes. As such, in one example, 4 concurrent requests for an item can be placed under the assumption that 3 will not actually yield an order. FIG. 19 shows a non-limiting example of an order timeslot table.

### Future Orders and Modes

The future order may comprise one or more of the plurality of items for delivery by one or more experts, a consumer address, and a delivery timeslot.

The server future mode application may comprise a communication module, a zoning module, and an availabilities module.

The communication module may receive at least the items, the experts, and the MIUs from the server processor. The communication module may additionally or alternatively receive a future order from the consumer processor.

The zoning module may assign a zone to each future order based on the consumer address. The availabilities module may determine in parallel a plurality of future delivery schemes for each of a plurality of future days based on the zone, the experts, the MIUs, or any combination thereof. The future delivery scheme may comprise a plurality of the future orders within a delivery window on one of the future days. The zone may comprise a zip code, a distance from a GPS point, a GPS boundary, a street boundary, a building, a campus, or any combination thereof. Each zone may have a unique population density, historical order density, current order density, or any combination thereof. Zones with higher population and/or historical order densities may be assigned a greater number and/or density of MIUs to fulfil the greater demand therein.

In some embodiments, the filter module applies a second operational rule in parallel for each for each future day for each future order in each zone. In some embodiments, the scorer module applies the third operational rule for each for each future day for each future order in each zone. In some embodiments, the filter module applies a second operational rule in parallel for each timeslot in each future day for each future order in each zone. In some embodiments, the scorer module applies the third operational rule for each for each timeslot in each future day for each future order in each zone.

In some embodiments, the filter module applying a second operational rule and the scorer module applying the third operational rule occurs after a set number of orders. In some embodiments, the filter module applying a second operational rule and the scorer module applying the third operational rule occurs after a set number of orders are received for a single zone. The set number of orders may be configured and adjusted to ensure that a sufficient number of limitations and parameters are received before calculating a future schedule for an entire zone. The set number of orders may depend on a population density, a historical order quantity, a consumer density, a current number of MIUs in the zone, or any combination thereof.

In some embodiments, the filter module applies a second operational rule in parallel for each for each future day for each future order in each zone. In some embodiments, the scorer module applies the third operational rule for each for each future day for each future order in each zone. In some embodiments, the filter module applies a second operational rule in parallel for each timeslot in each future day for each future order in each zone. In some embodiments, the scorer module applies the third operational rule for each for each timeslot in each future day for each future order in each zone.

In some embodiments, the filter module applying a second operational rule and the scorer module applying the third operational rule occurs after a set number of orders. In some embodiments, the filter module applying a second operational rule and the scorer module applying the third operational rule occurs after a set number of orders are received for a single zone. The set number of orders may be configured and adjusted to ensure that a sufficient number of limitations and parameters are received before calculating a future schedule for an entire zone. The set number of orders may depend on a population density, a historical order quantity, a consumer density, a current number of MIUs in the zone, or any combination thereof.

### Out of Stock Orders and Backorder Modes

An out-of-stock order from a consumer processor may comprise an out-of-stock item or an unreleased item. The out-of-stock item may comprise a backorder item that is available for purchase, wherein no or limited stock is available in a zone or within a set distance from a consumer. The unreleased item may comprise an item that is not yet available for purchase by the public, but which will be available for purchase by the public after a set release date. For example, the out-of-stock item may comprise a new phone which is not currently being produced at a scale necessary to meet current demand in a geographic area. The unreleased item may comprise a new phone that advertised but set for release only on a future date.

The backorder application may comprise a communication module, a zoning module, and an availabilities module.

The communication module may receive at least the items, the experts, and the MIUs from the server processor. The communication module may additionally or alternatively receive the out-of-stock order from the consumer processor.

The zoning module may assign a zone to each out-of-stock order based on the consumer address.

The availabilities module may determine in parallel a plurality of backorder delivery schemes. The availabilities module may determine in parallel a plurality of backorder delivery schemes for each of a plurality of future days. The availabilities module may determine in parallel a plurality of backorder delivery schemes for each of a plurality of future days based on the zone, the experts, the MIUs, or any combination thereof. The backorder delivery scheme may comprise a plurality of the out-of-stock orders within a delivery window on one of the future days.

### Database of Items

In some embodiments, the platforms, systems, media, and methods described herein include a database of items. In some embodiments, an item comprises a good or service that can be purchased, rented or traded for by a customer. In some embodiments each item is associated with a skill requirement, comprising one or more skills that are required to deliver, explain, install, or handle the item. The skill requirement ensures that an expert designated to deliver and/or install the item has the knowledge and background necessary to fulfil the order and instillation in observance with the customer's needs. In some embodiments, the number of skill requirements associated with each item is 1, 2, 3, 4, 5, 6, 7, 8, 9, 10, 15, 20, 25, 30, 35, 40, 45, 50, or any increment therein. In some embodiments, the number of skill requirements associated with each item is greater than 50. As a non-limiting example, a computer item may be associated with skill requirements for lifting a computer, installing computer cables, installing certain applications and operating systems, and installing computer peripheral equipment.

In some embodiments, each item is further associated with a visit duration comprising one or a range of time periods which represent the time needed to deliver the item from the street, install the item, explain the item, or any combination thereof.

In some embodiments, each item is further associated with a burden score comprising one or more parameters related to a size, a weight, a number of lifters, a portability of the item, or any combination thereof. The burden score ensures that a sufficient number of experts are assigned to each delivery to properly handle and install the item, and/or to ensure that the mobile inventory unit (MIU) has sufficient room to store or deliver the item. As a non-limiting example, a burden score for a refrigerator requires two or more experts to carry the item, the height, width, depth, and weight of the refrigerator, a requirement that the refrigerator must be stored upright, or any combination thereof.

In some embodiments, each item is further associated with a time-of-day requirement comprising a specific time or range of times when the item should be delivered and installed for optimal customer experience and proper instillation. As a non-limiting example, an automatic porch light item may be associated with a time-of-day requirement of after 5:00 pm local time, to ensure that instillation and demonstration occurs at a time of day where the light can be seen and correctly triggered.

In some embodiments, each item is further associated with a stock keeping unit (SKU), which serves as a product and service identification code. In some embodiments, each item comprises a sticker or decal with a machine-readable bar code that encodes the SKU.

In some embodiments, each item is further associated with one or more add-on items or services that a customer may decide to purchase along with their original order. In one non-limiting example, a cellphone is associated with one or more add-on cases that fit that cellphone, and/or one or more data plans that can provide cellular reception to the phone.

In some embodiments, the database of items comprises about 2 items to about 10,000,000 items. In some embodiments, the database of items comprises at least about 2 items. In some embodiments, the database of items comprises at most about 10,000,000 items. In various embodiments, the database of items comprises about 2 items to about 5 items, about 2 items to about 10 items, about 2 items to about 20 items, about 2 items to about 50 items, about 2 items to about 100 items, about 2 items to about 1,000 items, about 2 items to about 10,000 items, about 2 items to about 100,000 items, about 2 items to about 1,000,000 items, about 2 items to about 10,000,000 items, about 2 items to about 10,000,000 items, about 5 items to about 10 items, about 5 items to about 20 items, about 5 items to about 50 items, about 5 items to about 100 items, about 5 items to about 1,000 items, about 5 items to about 10,000 items, about 5 items to about 100,000 items, about 5 items to about 1,000,000 items, about 5 items to about 10,000,000 items, about 5 items to about 10,000,000 items, about 10 items to about 20 items, about 10 items to about 50 items, about 10 items to about 100 items, about 10 items to about 1,000 items, about 10 items to about 10,000 items, about 10 items to about 100,000 items, about 10 items to about 1,000,000 items, about 10 items to about 10,000,000 items, about 10 items to about 10,000,000 items, about 20 items to about 50 items, about 20 items to about 100 items, about 20 items to about 1,000 items, about 20 items to about 10,000 items, about 20 items to about 100,000 items, about 20 items to about 1,000,000 items, about 20 items to about 10,000,000 items, about 20 items to about 10,000,000 items, about 50 items to about 100 items, about 50 items to about 1,000 items, about 50 items to about 10,000 items, about 50 items to about 100,000 items, about 50 items to about 1,000,000 items, about 50 items to about 10,000,000 items, about 50 items to about 10,000,000 items, about 100 items to about 1,000 items, about 100 items to about 10,000 items, about 100 items to about 100,000 items, about 100 items to about 1,000,000 items, about 100 items to about 10,000,000 items, about 100 items to about 10,000,000 items, about 1,000 items to about 10,000 items, about 1,000 items to about 100,000 items, about 1,000 items to about 1,000,000 items, about 1,000 items to about 10,000,000 items, about 1,000 items to about 10,000,000 items, about 10,000 items to about 100,000 items, about 10,000 items to about 1,000,000 items, about 10,000 items to about 10,000,000 items, about 10,000 items to about 10,000,000 items, about 100,000 items to about 1,000,000 items, about 100,000 items to about 10,000,000 items, about 100,000 items to about 10,000,000 items, about 1,000,000 items to about 10,000,000 items, about 1,000,000 items to about 10,000,000 items, or about 10,000,000 items to about 10,000,000 items. In various particular embodiments, the database of items comprises about 2 items, about 5 items, about 10 items, about 20 items, about 50 items, about 100 items, about 1,000 items, about 10,000 items, about 100,000 items, about 1,000,000 items, about 10,000,000 items, or about 10,000,000 items, including increments therein. In a non-limiting, exemplary embodiment, the database of items comprises more than 10,000,000 items.

### Database of Experts

In some embodiments, the platforms, systems, media, and methods described herein include a database of experts. In some embodiments, each expert comprises a technician and/or a delivery-person that can be tasked to deliver one or more items to an address of a customer, install the item, explain the use of the item, or any combination thereof. In some embodiments, each expert is associated with a skill proficiency that allows that expert to deliver, install, and/or explain one or more items, to ensure proper delivery, instillation, and/or explanation of the item. In a non-limiting example, an expert may be associated with a skill proficiency for installing Windows OS once the expert has received training regarding the instillation procedure, and/or is approved by an administrator as having the skills to install the Windows OS.

In some embodiments, each expert is further associated with a current expert schedule. In some embodiments, the current expert schedules comprises a current list of orders assigned to an expert, the delivery addresses associated with the orders assigned to an expert, the day-beginning location of the expert, a visit duration associated with the orders assigned to an expert, the day-ending location of the expert, a drive time between the addresses associated with two or more orders assigned to an expert, a drive time to a warehouse, or any combination thereof. In some embodiments, at least one of the day-beginning location of the expert and the day-ending location of the expert comprise a warehouse location where the expert reports to and/or a warehouse location where the expert picks up an MIU. In some embodiments, the expert schedule of one or more experts is updated in real-time as orders are received and assigned to one or more experts in the database of experts. In some embodiments, an expert schedule comprises, the address that the expert picks up their MIU, the address of the orders assigned to the expert, the visit duration of the items in the orders assigned to the expert, the time-of-day requirements duration of the items in the orders assigned to the expert, the driving time between the addresses of consecutive orders assigned to the expert, the driving time between the address of the first order of the day assigned to the expert and the address that the expert picks up their MIU, the driving time between the address of the last order of the day assigned to the expert and the address that the expert drops off their MIU, or any combination thereof.

In some embodiments, each expert in the database of experts is further associated with an expert inventory comprising one or more items that the expert is carrying on their body. In some embodiments, the expert inventory allows an expert to delivery an item of an order assigned to the expert, without an MIU. In one non-limiting example, an expert is assigned to a specific densely populated area and caries a specific expert inventory of one or more items, wherein the expert walks or uses public or private transportation to travel from one order address to another order address. In another non-limiting example, an expert assigned to an MIU can leave the MIU with an expert inventory of one or more items on their body to deliver one or more items to one or more addresses within walking distance, while a second expert stays in, and continues to operate, the MIU to fulfil other orders. In some embodiments, the expert inventory further comprises one or more of the add-on items.

In some embodiments, the database of experts comprises about 2 experts to about 50,000 experts. In some embodiments, the database of experts comprises at least about 2 experts. In some embodiments, the database of experts comprises at most about 50,000 experts. In various embodiments, the database of experts comprises about 2 experts to about 5 experts, about 2 experts to about 10 experts, about 2 experts to about 20 experts, about 2 experts to about 50 experts, about 2 experts to about 100 experts, about 2 experts to about 500 experts, about 2 experts to about 1,000 experts, about 2 experts to about 5,000 experts, about 2 experts to about 10,000 experts, about 2 experts to about 50,000 experts, about 5 experts to about 10 experts, about 5 experts to about 20 experts, about 5 experts to about 50 experts, about 5 experts to about 100 experts, about 5 experts to about 500 experts, about 5 experts to about 1,000 experts, about 5 experts to about 5,000 experts, about 5 experts to about 10,000 experts, about 5 experts to about 50,000 experts, about 10 experts to about 20 experts, about 10 experts to about 50 experts, about 10 experts to about 100 experts, about 10 experts to about 500 experts, about 10 experts to about 1,000 experts, about 10 experts to about 5,000 experts, about 10 experts to about 10,000 experts, about 10 experts to about 50,000 experts, about 20 experts to about 50 experts, about 20 experts to about 100 experts, about 20 experts to about 500 experts, about 20 experts to about 1,000 experts, about 20 experts to about 5,000 experts, about 20 experts to about 10,000 experts, about 20 experts to about 50,000 experts, about 50 experts to about 100 experts, about 50 experts to about 500 experts, about 50 experts to about 1,000 experts, about 50 experts to about 5,000 experts, about 50 experts to about 10,000 experts, about 50 experts to about 50,000 experts, about 100 experts to about 500 experts, about 100 experts to about 1,000 experts, about 100 experts to about 5,000 experts, about 100 experts to about 10,000 experts, about 100 experts to about 50,000 experts, about 500 experts to about 1,000 experts, about 500 experts to about 5,000 experts, about 500 experts to about 10,000 experts, about 500 experts to about 50,000 experts, about 1,000 experts to about 5,000 experts, about 1,000 experts to about 10,000 experts, about 1,000 experts to about 50,000 experts, about 5,000 experts to about 10,000 experts, about 5,000 experts to about 50,000 experts, or about 10,000 experts to about 50,000 experts. In various particular embodiments, the database of experts comprises about 2 experts, about 5 experts, about 10 experts, about 20 experts, about 50 experts, about 100 experts, about 500 experts, about 1,000 experts, about 5,000 experts, about 10,000 experts, or about 50,000 experts, including increments therein.

### Database of MIUs

In some embodiments, the platforms, systems, media, and methods described herein include a database of mobile inventory units (MIUs). In some embodiments, each MIU comprises a vehicle that is driven by an expert that is capable of storing one or more items. In some embodiments, each MIU is capable of storing one or more items for scheduled deliveries and/or one or more items for predicted deliveries. In some embodiments, each MIU is associated with a stock of items, comprising a list of items that are currently aboard the MIU, wherein the stock of items are loaded on the MIU with an intent to fulfill a certain delivery on a certain day, or wherein the stock of items are loaded on the MIU, and are available to be sold throughout one or more days as orders are submitted mid-day.

In some embodiments, each MIU is further associated with a current MIU position, comprising a parameter associated with the geographical or GPS position of the MIU as recorded by a GPS sensor within the MIU or through other mapping and positioning elements. In some embodiments, the current MIU position allows the system to more efficiently assign orders, and maintain the predetermined utilization threshold by ensuring that delivery driving times are minimized.

In some embodiments, each MIU is further associated with a current MIU schedule. In some embodiments, the current MIU schedules comprises a current list of orders assigned to an MIU, the delivery addresses associated with the orders assigned to an MIU, the day-beginning location of the MIU, a visit duration associated with the orders assigned to an MIU, the day-ending location of the MIU, a drive time between the addresses associated with two or more orders assigned to an MIU, a drive time to a warehouse, or any combination thereof. In some embodiments, at least one of the day-beginning location of the MIU and the day-ending location of the MIU comprise a warehouse location where the MIU is stored and/or restocked. In some embodiments, the MIU schedule of one or more MIUs is updated in real-time as orders are received and assigned to one or more MIUs in the database of MIUs. In some embodiments, an MIU schedule comprises, the day-beginning location of the MIU, the day-ending location of the MIU the address of the orders assigned to the MIU, the visit duration of the items in the orders assigned to the MIU, the time-of-day requirements duration of the items in the orders assigned to the MIU, the driving time between the addresses of consecutive orders assigned to the MIU, the driving time between the address of the first order of the day assigned to the MIU, the driving time between the address of the last order of the day assigned to the MIU, and the address that the MIU drops off their MIU, or any combination thereof.

In one non-limiting example, the MIU contains a stock of a first item, which is scheduled to be delivered to a first customer to fulfil a first order, and a stock of a second item, wherein no order is currently in place for the entire MIU stock of that item, but wherein analytics or learning software has predicted a high likelihood of demand for that item during mid-day orders.

In some embodiments, the database of MIUs comprises about 2 MIUs to about 50,000 MIUs. In some embodiments, the database of MIUs comprises at least about 2 MIUs. In some embodiments, the database of MIUs comprises at most about 50,000 MIUs. In various embodiments, the database of MIUs comprises about 2 MIUs to about 5 MIUs, about 2 MIUs to about 10 MIUs, about 2 MIUs to about 20 MIUs, about 2 MIUs to about 50 MIUs, about 2 MIUs to about 100 MIUs, about 2 MIUs to about 500 MIUs, about 2 MIUs to about 1,000 MIUs, about 2 MIUs to about 5,000 MIUs, about 2 MIUs to about 10,000 MIUs, about 2 MIUs to about 50,000 MIUs, about 5 MIUs to about 10 MIUs, about 5 MIUs to about 20 MIUs, about 5 MIUs to about 50 MIUs, about 5 MIUs to about 100 MIUs, about 5 MIUs to about 500 MIUs, about 5 MIUs to about 1,000 MIUs, about 5 MIUs to about 5,000 MIUs, about 5 MIUs to about 10,000 MIUs, about 5 MIUs to about 50,000 MIUs, about 10 MIUs to about 20 MIUs, about 10 MIUs to about 50 MIUs, about 10 MIUs to about 100 MIUs, about 10 MIUs to about 500 MIUs, about 10 MIUs to about 1,000 MIUs, about 10 MIUs to about 5,000 MIUs, about 10 MIUs to about 10,000 MIUs, about 10 MIUs to about 50,000 MIUs, about 20 MIUs to about 50 MIUs, about 20 MIUs to about 100 MIUs, about 20 MIUs to about 500 MIUs, about 20 MIUs to about 1,000 MIUs, about 20 MIUs to about 5,000 MIUs, about 20 MIUs to about 10,000 MIUs, about 20 MIUs to about 50,000 MIUs, about 50 MIUs to about 100 MIUs, about 50 MIUs to about 500 MIUs, about 50 MIUs to about 1,000 MIUs, about 50 MIUs to about 5,000 MIUs, about 50 MIUs to about 10,000 MIUs, about 50 MIUs to about 50,000 MIUs, about 100 MIUs to about 500 MIUs, about 100 MIUs to about 1,000 MIUs, about 100 MIUs to about 5,000 MIUs, about 100 MIUs to about 10,000 MIUs, about 100 MIUs to about 50,000 MIUs, about 500 MIUs to about 1,000 MIUs, about 500 MIUs to about 5,000 MIUs, about 500 MIUs to about 10,000 MIUs, about 500 MIUs to about 50,000 MIUs, about 1,000 MIUs to about 5,000 MIUs, about 1,000 MIUs to about 10,000 MIUs, about 1,000 MIUs to about 50,000 MIUs, about 5,000 MIUs to about 10,000 MIUs, about 5,000 MIUs to about 50,000 MIUs, or about 10,000 MIUs to about 50,000 MIUs. In various particular embodiments, the database of MIUs comprises about 2 MIUs, about 5 MIUs, about 10 MIUs, about 20 MIUs, about 50 MIUs, about 100 MIUs, about 500 MIUs, about 1,000 MIUs, about 5,000 MIUs, about 10,000 MIUs, or about 50,000 MIUs, including increments therein.

### Database of Warehouses

In some embodiments, the platforms, systems, media, and methods described herein include a database of warehouses, each warehouse associated with a warehouse inventory comprising an inventory of one or more items that are available for purchase, order, and deliver by a user. In some embodiments, each warehouse is further associated with a warehouse location, comprising a street address or GPS location of the one or more warehouses.

In some embodiments, the database of warehouses comprises about 2 warehouses to about 50,000 warehouses. In some embodiments, the database of warehouses comprises at least about 2 warehouses. In some embodiments, the database of warehouses comprises at most about 50,000 warehouses. In various embodiments, the database of warehouses comprises about 2 warehouses to about 5 warehouses, about 2 warehouses to about 10 warehouses, about 2 warehouses to about 20 warehouses, about 2 warehouses to about 50 warehouses, about 2 warehouses to about 100 warehouses, about 2 warehouses to about 500 warehouses, about 2 warehouses to about 1,000 warehouses, about 2 warehouses to about 5,000 warehouses, about 2 warehouses to about 10,000 warehouses, about 2 warehouses to about 50,000 warehouses, about 5 warehouses to about 10 warehouses, about 5 warehouses to about 20 warehouses, about 5 warehouses to about 50 warehouses, about 5 warehouses to about 100 warehouses, about 5 warehouses to about 500 warehouses, about 5 warehouses to about 1,000 warehouses, about 5 warehouses to about 5,000 warehouses, about 5 warehouses to about 10,000 warehouses, about 5 warehouses to about 50,000 warehouses, about 10 warehouses to about 20 warehouses, about 10 warehouses to about 50 warehouses, about 10 warehouses to about 100 warehouses, about 10 warehouses to about 500 warehouses, about 10 warehouses to about 1,000 warehouses, about 10 warehouses to about 5,000 warehouses, about 10 warehouses to about 10,000 warehouses, about 10 warehouses to about 50,000 warehouses, about 20 warehouses to about 50 warehouses, about 20 warehouses to about 100 warehouses, about 20 warehouses to about 500 warehouses, about 20 warehouses to about 1,000 warehouses, about 20 warehouses to about 5,000 warehouses, about 20 warehouses to about 10,000 warehouses, about 20 warehouses to about 50,000 warehouses, about 50 warehouses to about 100 warehouses, about 50 warehouses to about 500 warehouses, about 50 warehouses to about 1,000 warehouses, about 50 warehouses to about 5,000 warehouses, about 50 warehouses to about 10,000 warehouses, about 50 warehouses to about 50,000 warehouses, about 100 warehouses to about 500 warehouses, about 100 warehouses to about 1,000 warehouses, about 100 warehouses to about 5,000 warehouses, about 100 warehouses to about 10,000 warehouses, about 100 warehouses to about 50,000 warehouses, about 500 warehouses to about 1,000 warehouses, about 500 warehouses to about 5,000 warehouses, about 500 warehouses to about 10,000 warehouses, about 500 warehouses to about 50,000 warehouses, about 1,000 warehouses to about 5,000 warehouses, about 1,000 warehouses to about 10,000 warehouses, about 1,000 warehouses to about 50,000 warehouses, about 5,000 warehouses to about 10,000 warehouses, about 5,000 warehouses to about 50,000 warehouses, or about 10,000 warehouses to about 50,000 warehouses. In various particular embodiments, the database of warehouses comprises about 2 warehouses, about 5 warehouses, about 10 warehouses, about 20 warehouses, about 50 warehouses, about 100 warehouses, about 500 warehouses, about 1,000 warehouses, about 5,000 warehouses, about 10,000 warehouses, or about 50,000 warehouses, including increments therein.

### Combinator Module

In some embodiments, the platforms, systems, media, and methods described herein include a combinator module applying a first operational rule to the order, the experts, and the one or more MIUs, to determine a plurality of possible delivery schemes that adhere to the first operational rule. In some embodiments, the combinator module further applies the first operational rule to the warehouses. In some embodiments, the combinator module applies the first operational rule in real-time, and without reprograming the server application. In some embodiments, the combinator module determines all the possible delivery schemes for each order that comply with the first operational rule, wherein each delivery scheme comprises a selection of one or more experts and a MIU.

In some embodiments the first rule comprises an item cost importance factor, an item demand factor, an item volume factor, an item promotion factor, an MIU stock factor, a warehouse stock factor, a visit location factor, a travel time importance factor, a specific expert utilization factor, an order split-ability factor, a predicting demand factor, or any combination thereof.

In some embodiments, the item cost importance factor comprises the margin of profit made by selling the item, the loss associated with not selling the item, the predicted sales price of the product, or any combination thereof. The cost importance factor may be set by a marking partner, an administrator, or both. In some embodiments, the item demand factor comprises a parameter related to the previous volume of sales, the predicted volume of sales, or any combination thereof.

In some embodiments the item volume factor comprises a parameter related to the physical volume of the box or container of that item and/or the volume required to store and/or deliver the item.

In some embodiments the item promotion factor comprises a parameter related to an increase or decrease in the revenue garnered from delivering an item associated with a current sale or deal of the item.

In some embodiments, the MIU stock factor comprises a parameter related to a volume of the item, a weight of the item, a requirement that the item be stacked upright, a fragility of the item, or any combination thereof.

In some embodiments, the MIU warehouse factor comprises a parameter related to the volume of the item, a weight of the item, a requirement that the item be stacked upright, a fragility of the item, or any combination thereof.

In some embodiments, the visit location factor comprises a parameter related to an interior or an exterior instillation directive, whether the item can be carried upstairs, the clearance required to deliver and install the item, the weight of the item, the volume of the item, a fragility of the item, or any combination thereof.

In some embodiments, the travel time importance factor comprises a parameter related to a weight given to the travel time between deliveries or to a delivery. As a non-limiting example, an item with a high cost and a high demand may be associated with a low travel time importance factor, because the potential gains associated with selling a large quantity of that item as fast as possible outweigh the costs associated with travel.

In some embodiments, the specific expert utilization factor comprises a parameter related to the percentage of time that an expert spends with a customer and is not in transit or performing a pickup.

In some embodiments, an order split-ability factor comprises a parameter related to whether or not one or more of a plurality of items that are ordered together can be delivered separately. In one non-limiting example, in an order for a cell phone and cell phone case, the cell phone case can have a split-ability factor indicating that it can be delivered separately if none are in the stock of the MIU or the expert.

In some embodiments, a predicting demand factor comprises predicting demand to load one or more mobile inventory vehicles. Overtime machine learning and artificial intelligence may be leveraged to predict demand.

### Filter Module

In some embodiments, the platforms, systems, media, and methods described herein include a filter module applying a second operational rule to the plurality of possible delivery schemes, to select two or more filtered delivery schemes that adhere to the second operational rule.

In some embodiments the second rule comprises an item cost importance factor, an item demand factor, an item volume factor, an item promotion factor, an MIU stock factor, a warehouse stock factor, a visit location factor, a travel time importance factor, a specific expert utilization factor, an order split-ability factor, or any combination thereof. In some embodiments, the filter module applies the second operational rule in real-time, and without reprograming the server application. In some embodiments, the filter module filters all the possible delivery schemes for each order, and removes delivery schemes that do not comply with the second operational rule, wherein each delivery scheme comprises a selection of one or more experts and a MIU.

### Scorer Module

In some embodiments, the platforms, systems, media, and methods described herein include a scorer module applying a third operational rule to the filtered delivery schemes, to score the filtered delivery schemes and determine which filtered delivery scheme has the best score.

In some embodiments the third rule comprises an item cost importance factor, an item demand factor, an item volume factor, an item promotion factor, an MIU stock factor, a warehouse stock factor, a visit location factor, a travel time importance factor, a specific expert utilization factor, an order split-ability factor, or any combination thereof. In some embodiments, the combinator module applies the third operational rule in real-time, and without reprograming the server application. In some embodiments, the scorer module scores all the possible delivery schemes for each order, to apply a score to each delivery scheme based on the third operational rule, wherein each delivery scheme comprises a selection of one or more experts and a MIU. In some embodiments, the delivery scheme with the best score comprises the most optimal scheme per the third operational rule.

### Stocking Module

In some embodiments, the platforms, systems, media, and methods described herein further comprises an MIU stocking module applying a fourth operational rule to at least one of the database of items, the database of experts, and the database of one or more MIUs, to determine an MIU inventory for one or more of the MIUs that adheres to the fourth operational rule.

### Utilization Threshold

In some embodiments, the platforms, systems, media, and methods described herein include features to maximize expert utilization such that the utilization exceeds a predetermined utilization threshold. In some embodiments, the predetermined utilization threshold is measured in dollars of revenue/expert/minute, and wherein the predetermined utilization threshold is at least 2 dollars of revenue/expert/minute. In some embodiments, the predetermined utilization threshold is measured as a percentage of a shift of the expert that is spent with a customer, and wherein the predetermined utilization threshold is at least 40%. In some embodiments, unpaid deliveries are not included towards calculating the utilization threshold.

In some embodiments, the adherence to the utilization threshold ensures that the platform is sufficiently profitable when accounting for costs comprising expert, gas, vehicle, and storage costs. In some embodiments, at least one of the first rule, the second rule, and the third rule are configured to ensure that the utilization threshold is met. In some embodiments, the capability of the platform to update at least one of the first rule, the second rule, and the third rule in real-time without reprograming the server application, enables the achievement of the predetermined utilization threshold.

It can be easily determined by one with ordinary skill in the art that the predetermined utilization threshold can be raised or lowered depending on the ratio between gas/labor/storage fees and the market for consumer goods.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

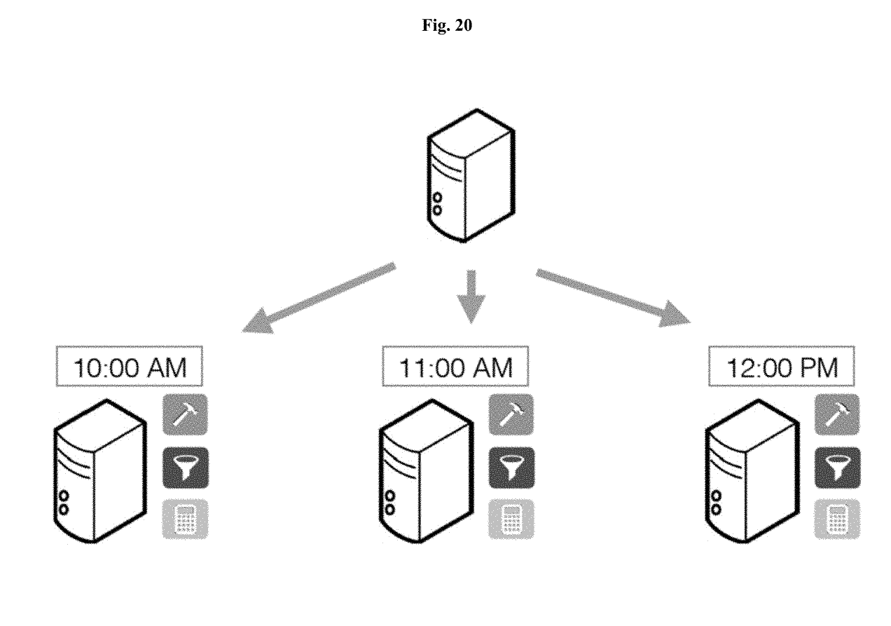

FIG. 20 shows a non-limiting example of a process flow diagram; in this case, a diagram illustrating a process of selecting a delivery scheme with a server processor;

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

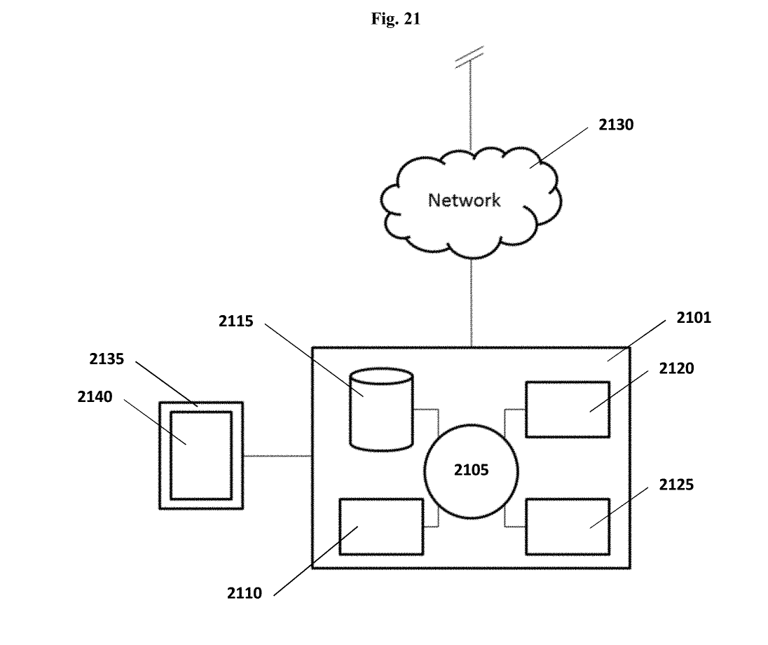

Referring to FIG. 21, in a particular embodiment, a digital processing device 2101 regulates various aspects of platforms, systems, media, and methods of the present disclosure, such as, for example, maintaining a database of items, maintaining a database of experts, receiving, via a graphic user interface (GUI) a requests from a consumer for expert delivery of items, identifying experts having requisite skill proficiencies time available; presenting, via a GUI, timeslots to the consumer; and selecting an identified expert based on shortest travel time to maximize utilization. In this embodiment, the digital processing device 2101 includes a central processing unit (CPU, also “processor” and “computer processor” herein) 2105, which is optionally a single core, a multi core processor, or a plurality of processors for parallel processing. The digital processing device 2101 also includes memory or memory location 2110 (e.g., random-access memory, read-only memory, flash memory), electronic storage unit 2115 (e.g., hard disk), communication interface 2120 (e.g., network adapter) for communicating with one or more other systems, and peripheral devices 2125, such as cache, other memory, data storage and/or electronic display adapters. The memory 2110, storage unit 2115, interface 2120 and peripheral devices 2125 are in communication with the CPU 2105 through a communication bus (solid lines), such as a motherboard. The storage unit 2115 comprises a data storage unit (or data repository) for storing data. The digital processing device 2101 is optionally operatively coupled to a computer network (“network”) 2130 with the aid of the communication interface 2120. The network 2130, in various cases, is the internet, an internet, and/or extranet, or an intranet and/or extranet that is in communication with the internet. The network 2130, in some cases, is a telecommunication and/or data network. The network 2130 optionally includes one or more computer servers, which enable distributed computing, such as cloud computing. The network 2130, in some cases, with the aid of the device 2101, implements a peer-to-peer network, which enables devices coupled to the device 2101 to behave as a client or a server.

Continuing to refer to FIG. 21, the CPU 2105 is configured to execute a sequence of machine-readable instructions, embodied in a program, application, and/or software. The instructions are optionally stored in a memory location, such as the memory 2110. The instructions are directed to the CPU 2105, which subsequently program or otherwise configure the CPU 2105 to implement methods of the present disclosure. Examples of operations performed by the CPU 2105 include fetch, decode, execute, and write back. The CPU 2105 is, in some cases, part of a circuit, such as an integrated circuit. One or more other components of the device 2101 are optionally included in the circuit. In some cases, the circuit is an application specific integrated circuit (ASIC) or a field programmable gate array (FPGA).

Continuing to refer to FIG. 21, the storage unit 2115 optionally stores files, such as drivers, libraries and saved programs. The storage unit 2115 optionally stores user data, e.g., user preferences and user programs. The digital processing device 2101, in some cases, includes one or more additional data storage units that are external, such as located on a remote server that is in communication through an intranet or the internet.

Continuing to refer to FIG. 21, the digital processing device 2101 optionally communicates with one or more remote computer systems through the network 2130. For instance, the device 2101 optionally communicates with a remote computer system of a user. Examples of remote computer systems include personal computers (e.g., portable PC), slate or tablet PCs (e.g., Apple® iPad, Samsung® Galaxy Tab, etc.), smartphones (e.g., Apple® iPhone, Android-enabled device, Blackberry®, etc.), or personal digital assistants.

Methods as described herein are optionally implemented by way of machine (e.g., computer processor) executable code stored on an electronic storage location of the digital processing device 2101, such as, for example, on the memory 2110 or electronic storage unit 2115. The machine executable or machine readable code is optionally provided in the form of software. During use, the code is executed by the processor 2105. In some cases, the code is retrieved from the storage unit 2115 and stored on the memory 2110 for ready access by the processor 2105. In some situations, the electronic storage unit 2115 is precluded, and machine-executable instructions are stored on the memory 2110.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

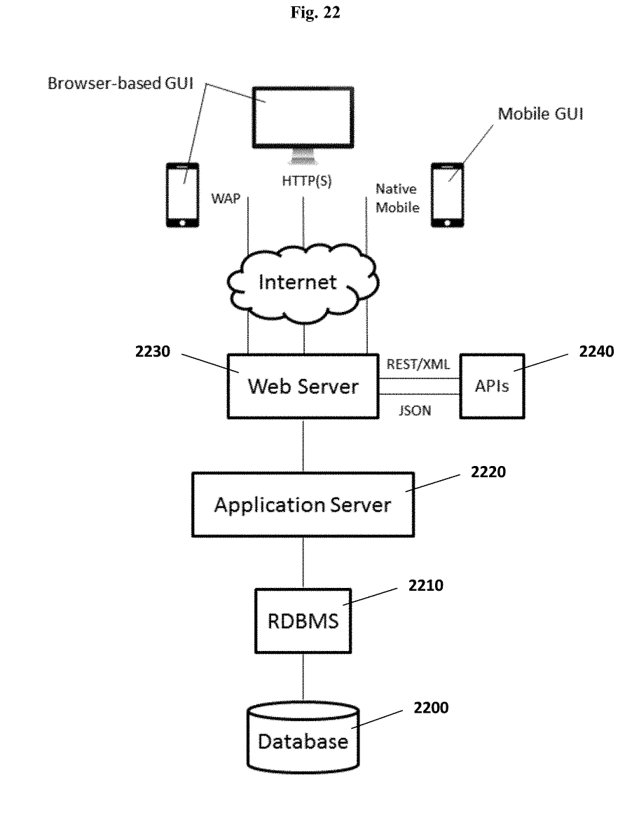

Referring to FIG. 22, in a particular embodiment, an application provision system comprises one or more databases 2200 accessed by a relational database management system (RDBMS) 2210. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 2220 (such as Java servers, .NET servers, PHP servers, and the like) and one or more web servers 2230 (such as Apache, IIS, GWS and the like). The web server(s) optionally expose one or more web services via app application programming interfaces (APIs) 2240. Via a network, such as the internet, the system provides browser-based and/or mobile native user interfaces.

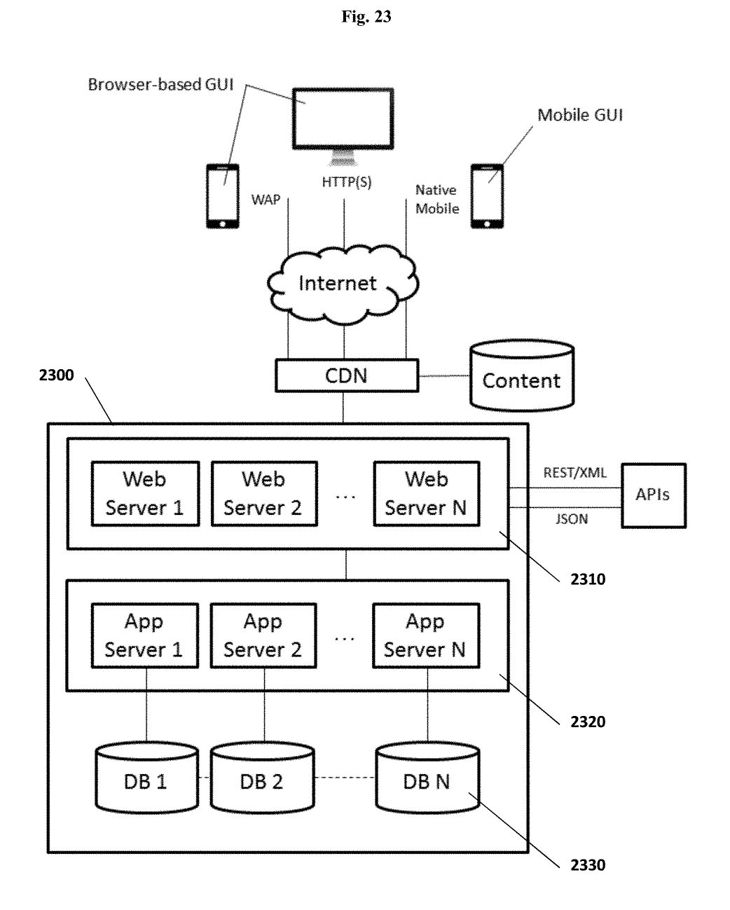

Referring to FIG. 23, in a particular embodiment, an application provision system alternatively has a distributed, cloud-based architecture 2300 and comprises elastically load balanced, auto-scaling web server resources 2310, and application server resources 2320 as well synchronously replicated databases 2330.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of item, expert, consumer, skill, schedule, visit, and travel time information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1—Expert Schedule

An expert starts their day by commuting to their car pickup location. In smaller markets, there will be one location which will be their car pickup location. In larger markets, there will be multiple car pickup locations comprising one main car pickup location and multiple auxiliary car pickup locations. Each car pickup location comprises a warehouse with an inventory and parking spaces.

When an expert arrives at the car pickup location, they are assigned to a specific vehicle, wherein each vehicle is well maintained and contains a highly secure lock box. Each vehicle is loaded with a set of inventory for orders that have already been scheduled for the day as well as a set of inventory that can be sold throughout the day. In some embodiments, the inventory that can be sold throughout the day comprises high-selling inventory that is expected to be ordered during the day without requiring an expert to drive back to the car pickup location. This mobile inventory allows for reduced travel time and increases the ability to provide same-day delivery. Once the expert has finished their shift, they return to the car pickup location and drop off their vehicle. The vehicle can then be restocked in preparation for the next shift.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A multimodal logistics platform configured to schedule a plurality of real-time orders and future orders within a set processing period, the platform comprising:
a) a consumer processor configured to provide a consumer application comprising a software module presenting an interface allowing a consumer to browse a plurality of items and submit one or more of the plurality of real-time orders and future orders, each real-time order and future order comprising one or more of the plurality of items for delivery by one or more experts, a consumer address, and a delivery timeslot; and
b) a server processor configured to provide a server application comprising:
(i) a database of items, each item associated with a skill requirement, a visit duration, a burden score, a time-of-day requirement, and a SKU;
(ii) a database of experts, each expert associated with a skill proficiency, and a current expert schedule; and
(iii) a database of one or more mobile inventory units (MIUs), each MIU associated with a stock of items, a current MIU position, and a current MIU schedule; and
c) a scheduling parallel processor configured to provide:
(i) a server real-time mode application comprising:
A) a communication module receiving at least the items, the experts, and the MIUs from the server processor, and receiving the real-time orders from the consumer processor;
B) a combinator module applying a first operational rule in parallel to the real-time orders, the experts, and the one or more MIUs, based on the real-time order, to determine, a plurality of real-time delivery schemes that adhere to the first operational rule;
C) a filter module applying a second operational rule to the plurality of real-time delivery schemes, to select two or more filtered real-time delivery schemes that adhere to the second operational rule; and
D) a scorer module applying a third operational rule to the filtered real-time delivery schemes, to score the filtered real-time delivery schemes and determine which filtered real-time delivery scheme has the best score; and
(ii) a server future mode application comprising:
A) a communication module receiving at least the items, the experts, and the MIUs from the server processor, and receiving a future order from the consumer processor;
B) a zoning module assigning a zone to each future order based on the consumer address; and
C) an availabilities module determining in parallel a plurality of future delivery schemes for each of a plurality of future days based on the zone, the experts, the MIUs, or any combination thereof, wherein the future delivery scheme comprises a plurality of the future orders within a delivery window on one of the future days;
provided that the logistics platform is configured to meet or exceed a predetermined utilization threshold.

2. The platform of claim 1, wherein the predetermined utilization threshold is measured in dollars of revenue/expert/minute, and wherein the predetermined utilization threshold is at least 2 dollars of revenue/expert/minute.

3. The platform of claim 1, wherein the predetermined utilization threshold is measured as a percentage of a shift of the expert that is spent with a customer, and wherein the predetermined utilization threshold is at least 40%.

4. The platform of claim 1, wherein the server application further comprises a database of warehouses, each warehouse associated with a warehouse inventory and a warehouse location, and wherein the combinator module further applies the first operational rule to the warehouses.

5. The platform of claim 1, wherein the server application is configured to allow an administrator to modify at least one of the first operational rule, the second operational rule, and the third operational rule in real-time, and without reprograming the server application.

6. The platform of claim 1, wherein at least one of the server processor, the scheduling processor, and the consumer processor comprises a parallel processor.

7. The platform of claim 6, wherein the parallel processor comprises a distributed computing parallel processor.

8. The platform of claim 1, wherein the server application further comprises a notification module communicating a delivery update to the consumer.

9. The platform of claim 1, wherein the server application further comprises a scheduling module modifying the current expert schedule of at least one of the experts in real-time to include the filtered delivery scheme with the best score.

10. The platform of claim 1, wherein at least one of the combinator module applying the first operational rule, the filter module applying a second operational rule, and the scorer module applying the third operational rule occurs continuously.

11. The platform of claim 1, wherein at least one of the combinator module applying the first operational rule, the filter module applying a second operational rule, and the scorer module applying the third operational rule occurs periodically.

12. The platform of claim 1, wherein at least one of the combinator module applying the first operational rule, the filter module applying a second operational rule, and the scorer module applying the third operational rule occurs after a set number of real-time orders.

13. The platform of claim 1, wherein the server application is capable of updating at least one of the database of items, the database of experts and the database of one or more MIUs in real-time.

14. The platform of claim 1, wherein the server application further comprises an MIU stocking module applying a fourth operational rule to at least one of the database of items, the database of experts, and the database of one or more MIUs, to determine an MIU inventory for one or more of the MIUs that adheres to the fourth operational rule.

15. The platform of claim 1, wherein a set real-time prioritization percentage of the current expert schedule is dedicated to real-time orders.

16. The platform of claim 1, wherein the communication module of the server real-time mode application receives at least the items, the experts and the MIUs from the server processor before the combinator module applies the first operational rule.

17. The platform of claim 1, wherein scheduling parallel processor is further configured to provide a backorder application comprising:
a) a communication module receiving at least the items, the experts, and the MIUs from the server processor, and receiving an out-of-stock order from the consumer processor, wherein the item comprises an out-of-stock item or an unreleased item;
b) a zoning module assigning a zone to each out-of-stock order based on the consumer address; and
c) an availabilities module determining in parallel a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

18. A multimodal logistics computer-implemented system comprising: a digital processing device comprising: at least one processor, an operating system configured to perform executable instructions, a memory, and a computer program including instructions executable by the digital processing device to create a high-utilization product expert logistics application comprising:
a) a consumer module receiving a real-time order and a future order submitted by a consumer, the real-time order and the future order comprising one or more items selected from a plurality of items for delivery by one or more experts, a consumer address, and a delivery timeslot;
b) a database of items, each item associated with a skill requirement, a visit duration, a burden score, a time-of-day requirement, and a SKU;
c) a database of experts, each expert associated with a skill proficiency and a current expert schedule;
d) a database of one or more mobile inventory units (MIUs), each MIU associated with a stock of items, a current MIU position, and a current MIU schedule;
e) a real-time parallel scheduling module:
(i) applying a first operational rule to the real-time order, the experts, and the one or more MIUs, to determine a plurality of possible delivery schemes that adhere to the first operational rule;
(ii) applying a second operational rule to the plurality of possible delivery schemes, to select two or more filtered delivery schemes that adhere to the second operational rule; and
(iii) applying a third operational rule to the filtered delivery schemes, to score the filtered delivery schemes and determine which filtered delivery scheme has the best score; and
f) a future parallel scheduling module:
(i) assigning a zone to each future order based on the consumer address; and
(ii) determining in parallel a plurality of future delivery schemes for each of a plurality of future days based on the zone, the experts, the MIUs, or any combination thereof, wherein the future delivery scheme comprises a plurality of the orders within a delivery window on one of the future days;
provided that the application configured to, on average, meet or exceed a predetermined utilization threshold.

19. The system of claim 18, wherein the predetermined utilization threshold is measured as dollars of revenue/expert/minute, and wherein the predetermined utilization threshold is at least 2 dollars of revenue/expert/minute.

20. The system of claim 18, wherein the predetermined utilization threshold is measured as a percentage of a shift of the expert that is spent with a customer, and wherein the predetermined utilization threshold is at least 40%.

21. The system of claim 18, wherein at least one of the combinator module applying the first operational rule, the filter module applying a second operational rule, and the scorer module applying the third operational rule occurs after a set number of orders.

22. The system of claim 18, wherein the server application is capable of updating at least one of the database of items, the database of experts and the database of MIUS in real-time.

23. The system of claim 18, wherein the server application further comprises an MIU stocking module applying a fourth operational rule to at least one of the database of items, the database of experts, and the database of one or more MIUs, to determine an MIU inventory for one or more of the MIUs that adheres to the fourth operational rule.

24. The system of claim 18, wherein a set real-time prioritization percentage of the current expert schedule is dedicated to real-time orders.

25. The system of claim 18, wherein scheduling parallel processor is further configured to provide a backorder application comprising:
a) a communication module receiving at least the items, the experts, and the MIUs from the server processor, and receiving the future orders from the consumer processor, wherein the item comprises an out-of-stock item or an unreleased item;
b) a zoning module, assigning a zone to each future order based on the consumer address; and
c) an availabilities module determining in parallel a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.

26. A parallel computer-implemented multimodal method of providing high-utilization logistics for a scheduling a plurality of real-time orders and future orders within a set processing period, the method comprising:
a) maintaining, in a computer storage, a database of items, each item associated with a skill requirement, a visit duration, a burden score, a time-of-day requirement, and a SKU;
b) maintaining, in the computer storage, a database of experts, each expert associated with a skill proficiency and a current expert schedule;
c) maintaining, in the computer storage, a database of one or more mobile inventory units (MIUs), each MIU associated with a stock of items, a current MIU position, and a current MIU schedule;
d) receiving, by a computer, a real-time order and a future order from a consumer for delivery of one or more of the items to a consumer address, during a delivery timeslot, the delivery by at least one of the experts;
e) performing a parallel real-time mode comprising:
(i) determining, by the computer, one or more possible delivery schemes by applying a first operational rule to the real-time order, the experts, and the one or more MIUs;
(ii) filtering, by the computer, the one or more possible delivery schemes to select one or more filtered delivery schemes, wherein the filtering comprises applying a second operational rule to the possible delivery schemes; and
(iii) scoring, by the computer, the filtered delivery schemes by applying a third operational rule to the filtered delivery schemes and determining which filtered delivery scheme has the best score; and
f) performing a parallel future mode comprising:
(i) assigning, by the computer, a zone to each future order based on the consumer address; and
(ii) determining in parallel, by the computer, a plurality of future delivery schemes for each of a plurality of future days based on the zone, the experts, the MIUs, or any combination thereof, wherein the future delivery scheme comprises a plurality of the orders within a delivery window on one of the future days;
wherein the filtered delivery scheme with the best score or the future delivery scheme meets or exceeds a predetermined utilization threshold.

27. The method of claim 26, wherein the predetermined utilization threshold is measured as dollars of revenue/expert/minute, and wherein the predetermined utilization threshold is at least 2 dollars of revenue/expert/minute.

28. The method of claim 26, wherein the predetermined utilization threshold is measured as a percentage of a shift of the expert that is spent with a customer, and wherein the predetermined utilization threshold is at least 40%.

29. The method of claim 26, further comprising communicating, by a dispatch module, the filtered delivery scheme with the best score to an administrator.

30. The method of claim 26, further comprising performing a backorder mode comprising:
a) receiving, by the computer, at least the items, the experts, and the MIUs from the server processor, and receiving the future orders from the consumer processor, wherein the item comprises an out-of-stock item or an unreleased item;
b) assigning, by the computer, a zone to each future order based on the consumer address; and
c) determining, in parallel, by the computer, a plurality of backorder delivery schemes for each of a plurality of future days based on the zone, the experts, the MIUs, or any combination thereof, wherein the backorder delivery scheme comprises a plurality of the out-of-stock orders within a delivery window on one of the future days.
